(19) United States
(12) Patent Application Publication
(10) Pub. No.: US 2024/0318825 A1
(43) Pub. Date: Sep. 26, 2024

(54) COOKING DEVICE AND CONTROL METHOD THEREFOR

(71) Applicant: Samsung Electronics Co., Ltd., Suwon-si (KR)

(72) Inventors: Byunghwan KO, Suwon-si (KR); Jiwoong CHOI, Suwon-si (KR); Heejoon KANG, Suwon-si (KR); Younghoon WOO, Suwon-si (KR); Myoungjin HAM, Suwon-si (KR)

(73) Assignee: Samsung Electronics Co., Ltd., Suwon-si (KR)

(21) Appl. No.: 18/734,501

(22) Filed: Jun. 5, 2024

Related U.S. Application Data
(63) Continuation of application No. PCT/KR2022/018482, filed on Nov. 22, 2022.

(30) Foreign Application Priority Data
Dec. 15, 2021 (KR) 10-2021-0179971

(51) Int. Cl. F24C 7/08; F24C 15/10

(52) U.S. Cl. CPC F24C 7/083; F24C 7/087; F24C 15/106

(57) ABSTRACT

Provided is a cooking device capable of simultaneously controlling a plurality of power units without noise. In particular, provided is a cooking device for determining one operating frequency, based on operating frequencies of the plurality of power units overlapped on a location where a container is placed, and controlling an operation of a power unit by using the determined operating frequency.

### CROSS-REFERENCE TO RELATED APPLICATIONS

This application is a continuation of International Application No. PCT/KR2022/018482, filed Nov. 22, 2022, and claims foreign priority to Korean Application No. 10-2021-0179971, filed Dec. 15, 2021, which are incorporated herein by reference in their entireties.

### TECHNICAL FIELD

The present disclosure relates to a cooking device including a plurality of power units, and a control method therefor.

### BACKGROUND ART

A cooking device is a device for cooking by heating a container containing an object to be cooked, such as food. The cooking device may cook by heating the container through various methods. A cooking device based on an induction heating (IH) method generates a magnetic field by supplying a current to a burner. An eddy current is induced by the Faraday's Law as the magnetic field passes through a bottom surface of a conductive container placed on the burner of the cooking device where the magnetic field is generated. Accordingly, Joule heat is generated by surface resistance, and thus, the conductive container is heated, and an object to be cooked contained in the conductive container is cooked. As such, the cooking device based on the IH method uses a principle of IH in which electric energy is converted into heat energy.

The cooking device based on the IH method has a limited range of the burner controlled by one power unit. Accordingly, when a location where the container is placed is outside the range of the burner controlled by one power unit, only the burner controlled by one power unit is operated and a burner controlled by another power unit is not operated, and thus, a size of the container may be restricted.

When a plurality of power units are operated together according to the location where the container is placed, a resonant frequency difference between the plurality of power units may occur due to a deviation between components for each power unit and a difference between burner powers. When the resonant frequency difference between the plurality of power units is included in an audible frequency band, the cooking device may generate noise (audible noise) that may be perceived by a user. For example, when a resonant frequency of a first power unit is 30 KHz and a resonant frequency of a second power unit is 35 kHz, a resonant frequency difference between the first power unit and the second power unit is 5 kHz and thus is included in a range of audible frequency, i.e. 20 Hz to 20 kHz. Accordingly, when the first power unit and the second power unit are operated together, the user perceives noise. In particular, the noise may be greater when a first burner controlled by the first power unit and a second burner controlled by the second power unit are physically adjacent to each other.

### DISCLOSURE

### Technical Solution

A cooking device according to an embodiment of the present disclosure may include a plurality of burners. A cooking device according to an embodiment of the present disclosure includes a first power unit configured to control power of at least one first burner from among a plurality of burners. A cooking device according to an embodiment of the present disclosure includes a second power unit configured to control power of at least one second burner from among a plurality of burners. A cooking device according to an embodiment of the present disclosure includes at least one processor configured to, when a location where a container is placed is a location overlapping a portion of at least one first burner and a portion of at least one second burner, determine a third operating frequency, based on a first operating frequency of a first power unit and a second operating frequency of a second power unit, and control the first power unit and the second power unit to operate together by using the determined third operating frequency.

A control method, according to an embodiment of the present disclosure, for a cooking device that includes a first power unit configured to control power of at least one first burner from among a plurality of burners and a second power unit configured to control power of at least one second burner from among the plurality of burners, includes, when a location where a container is placed on the cooking device is a location overlapping a portion of the at least one first burner and a portion of the at least one second burner, determining a third operating frequency, based on a first operating frequency of the first power unit and a second operating frequency of the second power unit. The control method for a cooking device, according to an embodiment of the present disclosure, includes controlling the first power unit and the second power unit to operate together by using the determined third operating frequency.

### DESCRIPTION OF DRAWINGS

FIG. 1 is a diagram for describing a concept of an operation of a cooking device, according to an embodiment of the present disclosure.

FIG. 2 illustrates a structure of burners included in a cooking device, according to an embodiment of the present disclosure.

FIG. 3 illustrates a structure of burners included in a cooking device, according to an embodiment of the present disclosure.

FIG. 4 illustrates a structure of burners included in a cooking device, according to an embodiment of the present disclosure.

FIG. 5 illustrates a structure of burners included in a cooking device, according to an embodiment of the present disclosure.

FIG. 6 is a block diagram for describing functions of a cooking device, according to an embodiment of the present disclosure.

FIG. 7 illustrates operations of burners included in a cooking device, according to an embodiment of the present disclosure.

FIG. 8 is a block diagram for describing functions of a power unit included in a cooking device, according to an embodiment of the present disclosure.

FIG. 9 is a block diagram for describing functions of a cooking device, according to an embodiment of the present disclosure.

FIG. 10 illustrates operations of burners included in a cooking device, according to an embodiment of the present disclosure.

FIG. 11 is a functional block diagram for describing functions of a cooking device, according to an embodiment of the present disclosure.

FIG. 12 illustrates relationships between burners included in a cooking device and an input button included in a user interface, according to an embodiment of the present disclosure.

FIG. 13 illustrates burner information stored in a cooking device, according to an embodiment of the present disclosure.

FIG. 14 illustrates another burner information stored in a cooking device, according to an embodiment of the present disclosure.

FIG. 15 is a flowchart for describing a control method for a cooking device, according to an embodiment of the present disclosure.

FIG. 16 is a flowchart for describing a control method for a cooking device, according to an embodiment of the present disclosure.

### MODE FOR INVENTION

The terms used in the present disclosure will be briefly defined, and an embodiment of the present disclosure will be described in detail.

All terms including descriptive or technical terms which are used herein should be construed as having meanings that are obvious to one of ordinary skill in the art. However, the terms may have different meanings according to the intention of one of ordinary skill in the art, precedent cases, or the appearance of new technologies. Also, some terms may be arbitrarily selected by the applicant, and in this case, the meaning of the selected terms will be described in detail in the detailed description of an embodiment of the present disclosure. Thus, the terms used herein have to be defined based on the meaning of the terms together with the description throughout the specification.

When a part “includes” or “comprises” an element, unless there is a particular description contrary thereto, the part may further include other elements, rather than excluding the other elements. In addition, terms such as “unit (-er/or)” and “module” described in the present disclosure denote a unit that processes at least one function or operation, which may be implemented in hardware or software, or implemented in a combination of hardware and software.

Throughout the specification, when a part is “connected” to another part, the part may not only be “directly connected” to the other part, but may also be “electrically connected” to the other part with another element in between. In addition, when a part “comprises (includes)” a certain element, the part may further include another element instead of excluding the other element, unless otherwise stated.

Throughout the present disclosure, the expression “at least one of a, b, or c” indicates only a, only b, only c, both a and b, both a and c, both b and c, all of a, b, and c, or variations thereof.

Throughout the present disclosure, the terms such as first, second, etc. may be used to describe various components (or information), but the various components must not be limited to the above terms. The above terms are used only to distinguish one component (or information) from another. For example, without departing from the scope of the rights described in the present disclosure, a first component (or information) may be referred to as a second component (or information), and similarly, a second component (information) may be referred to as a first component (or information. The term and/or includes a combination of a plurality of related items or one item from among the plurality of related items.

Hereinafter, the present disclosure will be described in detail with reference to the accompanying drawings such that one of ordinary skill in the art may easily implement the embodiment of the present disclosure. However, an embodiment of the present disclosure may be implemented in various different forms and is not limited to an embodiment described herein. Also, in the drawings, parts irrelevant to the description are omitted in order to clearly describe an embodiment of the present disclosure, and like reference numerals designate like elements throughout the specification.

According to an embodiment of the present disclosure, a cooking device capable of blocking noise generated when a plurality of power units operate together, based on a location where a container is placed, and a control method therefor may be provided.

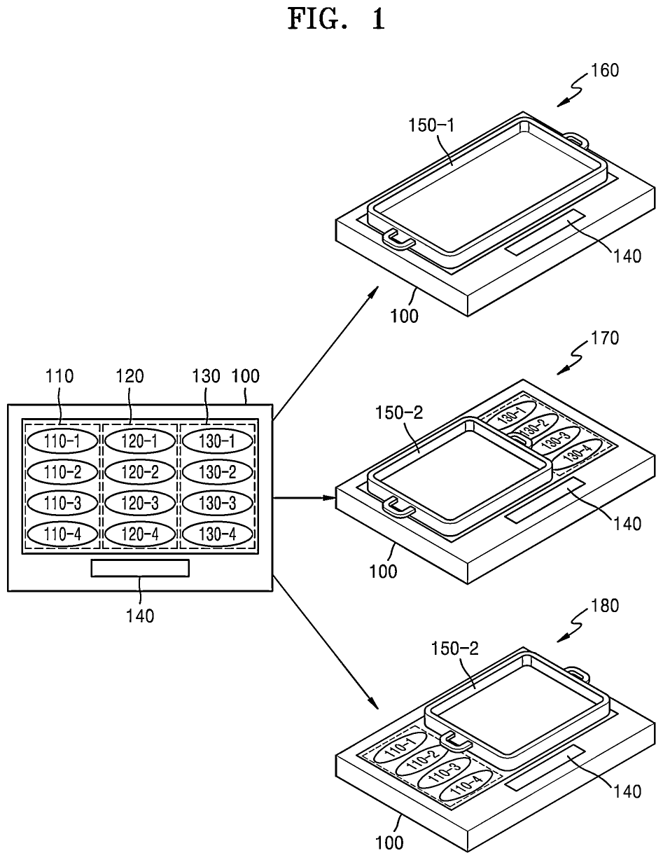

FIG. 1 is a diagram for describing a concept of an operation of a cooking device 100, according to an embodiment of the present disclosure.

The cooking device 100 according to an embodiment of the present disclosure includes a first power unit 110, a second power unit 120, a third power unit 130, first to fourth burners 110-1 to 110-4 of which powers are controlled by the first power unit 110, first to fourth burners 120-1 to 120-4 of which powers are controlled by the second power unit 120, first to fourth burners 130-1 to 130-4 of which powers are controlled by the third power unit 130, and a user interface 140.

Components included in the cooking device 100 according to an embodiment of the present disclosure are not limited to those shown in FIG. 1. For example, the cooking device 100 may include the first power unit 110 configured to control the powers of the first to fourth burners 110-1 to 110-4, the second power unit 120 configured to control the powers of the first to fourth burners 120-1 to 120-4, and the user interface 140. The first to third power units 110 to 130 may each be referred to as a power supply element configured to supply power to a corresponding burner.

The first to fourth burners 110-1 to 110-4, the first to fourth burners 120-1 to 120-4, and the first to fourth burners 130-1 to 130-4 may each indicate a heating area, a crater, or a cooking zone, which includes at least one working coil. The working coil may be configured as an induction heating coil for generating a magnetic field when a current flows.

The cooking device 100 according to an embodiment of the present disclosure may, when a container 150-1 or 150-2 is placed to overlap a plurality of burners and the plurality of burners are controlled by different power units, set resonant frequencies of the different power units to be the same and operate the different power units together, thereby reducing noise generated in the cooking device 100. A resonant frequency of a power unit generates a high-frequency induced magnetic field in a burner and may also be referred to as an operating frequency of the power unit. The high-frequency induced magnetic field corresponding to power desired by the burner is generated only when generation of the resonant frequency in the power unit is facilitated. The resonant frequency of the power unit is generated according to a combination of an inductor L that is changed according to the burner and a material of a container placed on the burner and a capacitor C included in an inverter circuit included in the power unit. Hereinafter, a resonant frequency will be referred to as an operating frequency.

Referring to a reference numeral 160 of FIG. 1, the container 150-1 overlaps all of the burners 110-1 to 110-4, 120-1 to 120-4, and 130-1 to 130-4. In the reference numeral 160 of FIG. 1, the cooking device 100 according to an embodiment of the present disclosure may set operating frequencies of the first power unit 110, the second power unit 120, and the third power unit 130 to be the same and operate the first power unit 110, the second power unit 120, and the third power unit 130 together.

The setting of the operating frequencies of the first power unit 110, the second power unit 120, and the third power unit 130 to be the same may be performed by the user interface 140. When the operating frequencies of the first power unit 110, the second power unit 120, and the third power unit 130 are set to be a same frequency by the user interface 140, the user interface 140 may be referred to as a master device of the cooking device 100 and the first power unit 110, the second power unit 120, and the third power unit 130 may be referred to as slave devices of the cooking device 100.

Also, the operating frequencies of the first power unit 110, the second power unit 120, and the third power unit 130 may be set to be a same frequency, based on communication between the first power unit 110, the second power unit 120, and the third power unit 130.

Referring to a reference numeral 170 of FIG. 1, the container 150-2 overlaps the first to fourth burners 110-1 to 110-4 and the first to fourth burners 120-1 to 120-4. In the reference numeral 170 of FIG. 1, the cooking device 100 according to an embodiment of the present disclosure may set the operating frequencies of the first power unit 110 controlling the first to fourth burners 110-1 to 110-4 and the second power unit 120 controlling the first to fourth burners 120-1 to 120-4 to be a same frequency and operate the first power unit 110 and the second power unit 120 together.

The setting of the operating frequencies of the first power unit 110 and the second power unit 120 to be a same frequency may be performed by the user interface 140. When the operating frequencies of the first power unit 110 and the second power unit 120 are set to be a same frequency by the user interface 140, the user interface 140 may be referred to as a master device in the cooking device 100 and the first power unit 110 and the second power unit 120 may be referred to as slave devices of the cooking device 100.

Also, the operating frequencies of the first power unit 110 and the second power unit 120 may be set to be a same frequency, based on communication between the first power unit 110 and the second power unit 120.

Referring to a reference numeral 180 of FIG. 1, the container 150-2 overlaps the first to fourth burners 120-1 to 120-4 and the first to fourth burners 130-1 to 130-4. The cooking device 100 according to an embodiment of the present disclosure may set the operating frequencies of the second power unit 120 controlling the first to fourth burners 120-1 to 120-4 and the third power unit 130 controlling the first to fourth burners 130-1 to 130-4 to be a same frequency and operate the second power unit 120 and the third power unit 130 together.

The setting of the operating frequencies of the second power unit 120 and the third power unit 130 to be a same frequency may be performed by the user interface 140. When the operating frequencies of the second power unit 120 and the third power unit 130 are set to be a same frequency by the user interface 140, the user interface 140 may be referred to as a master device in the cooking device 100 and the second power unit 120 and the third power unit 130 may be referred to as slave devices of the cooking device 100.

Also, the operating frequencies of the second power unit 120 and the third power unit 130 may be set to be a same frequency, based on communication between the second power unit 120 and the third power unit 130.

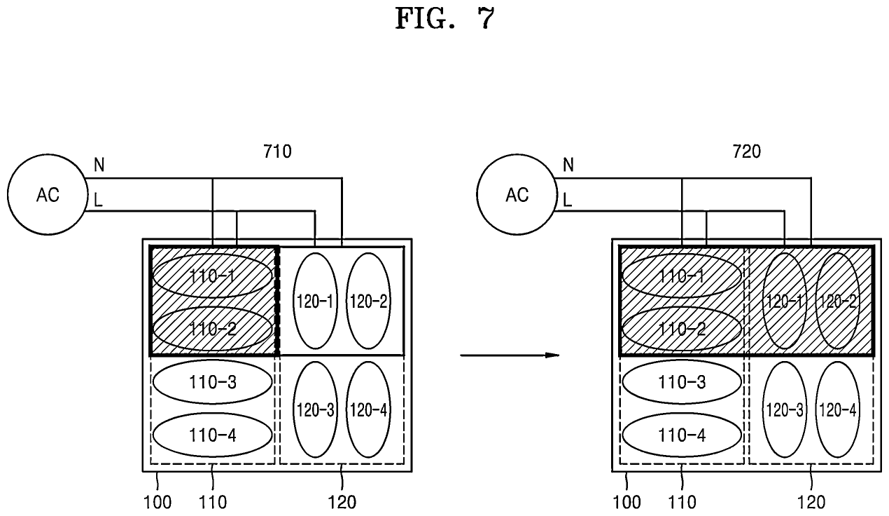

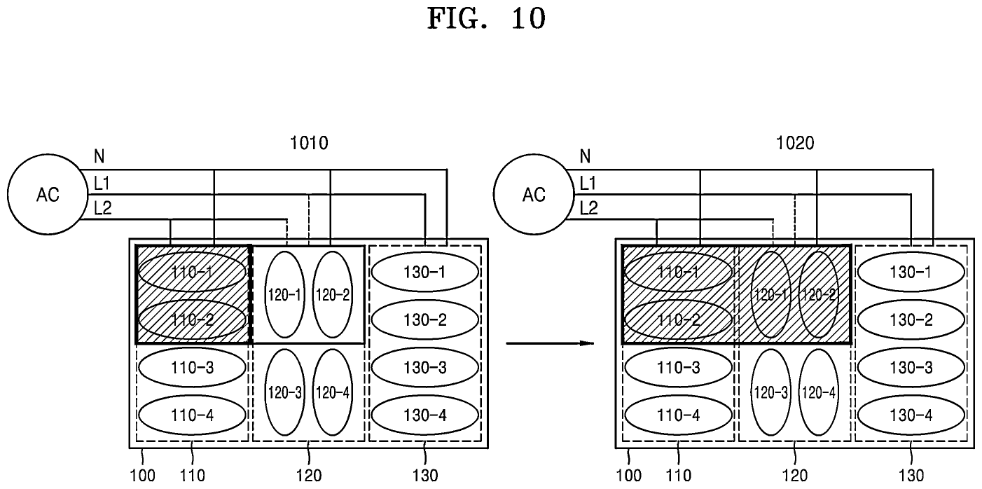

The burners 110-1 to 110-4, 120-1 to 120-4, and 130-1 to 130-4 shown in FIG. 1 all have oval shapes arranged horizontally so as to be closely arranged without dead zones. Accordingly, the cooking device 100 may operate regardless of a size of a container and a location where the container is placed. Example in which the burners 110-1 to 110-4, 120-1 to 120-4, and 130-1 to 130-4 included in the cooking device 100 and the container overlap each other, according to an embodiment of the present disclosure, are not limited to those shown in FIG. 1. For example, the burners 110-1 to 110-4, 120-1 to 120-4, and 130-1 to 130-4 included in the cooking device 100 according to an embodiment of the present disclosure and a container may overlap each other as will be described below with reference to FIG. 7 or 10.

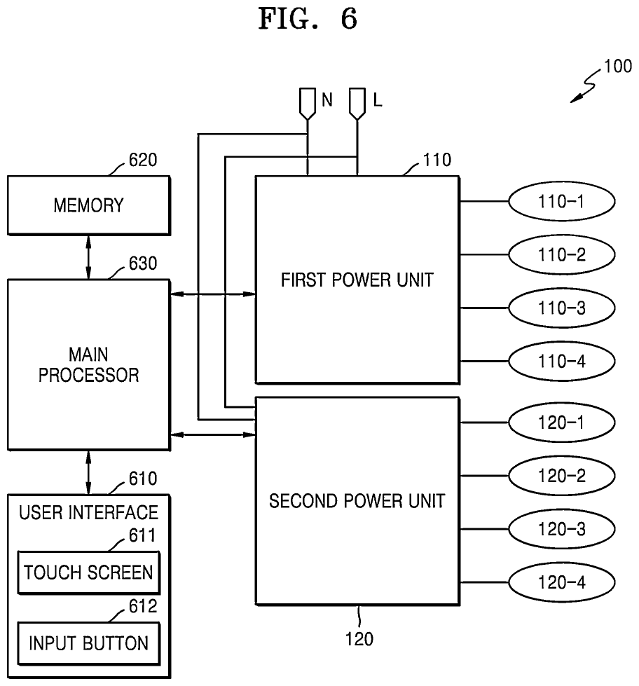

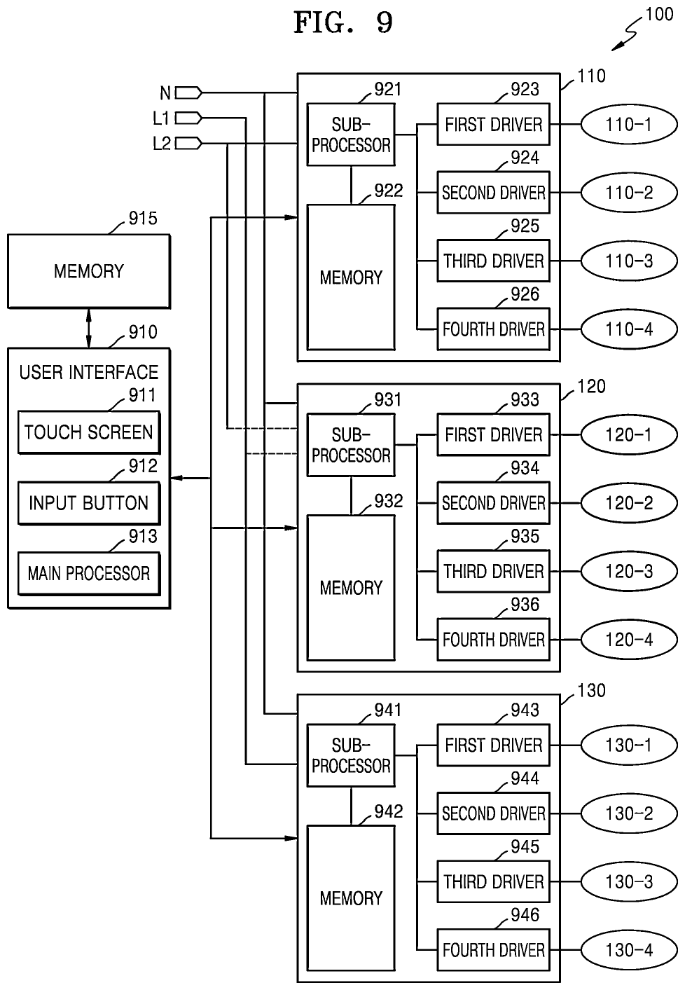

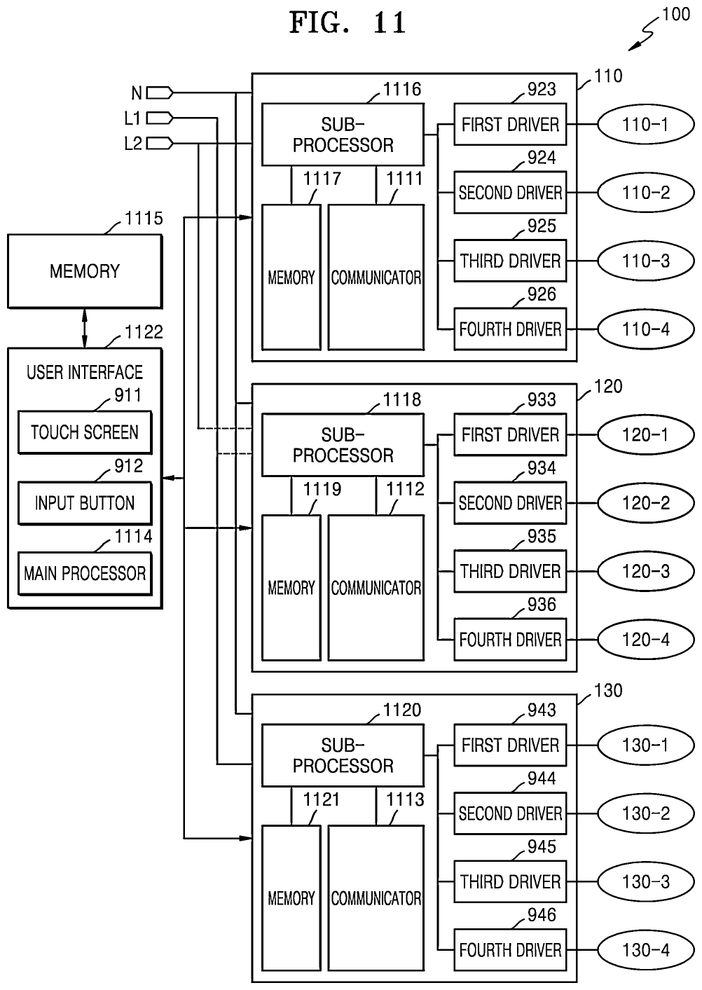

The user interface 140 included in the cooking device 100 of FIG. 1 may be a user interface 610 of FIG. 6, a user interface 910 of FIG. 9, or a user interface 1122 of FIG. 11, which will be described below. The first power unit 110 included in the cooking device 100 of FIG. 1 may be the first power unit 110 of FIG. 6, the first power unit 110 of FIG. 9, or the first power unit 110 of FIG. 11, which will be described below. The second power unit 120 included in the cooking device 100 of FIG. 1 may be the second power unit 120 of FIG. 6, the second power unit 120 of FIG. 9, or the second power unit 120 of FIG. 11, which will be described below. The third power unit 130 included in the cooking device 100 of FIG. 1 may be the third power unit 130 of FIG. 6, the third power unit 130 of FIG. 9, or the third power unit 130 of FIG. 11, which will be described below.

The cooking device 100 according to an embodiment of the present disclosure may be controlled by an external device, based on wireless communication, or may transmit a notification message to the external device. In this regard, the cooking device 100 may further include a communicator capable of performing communication with the external device.

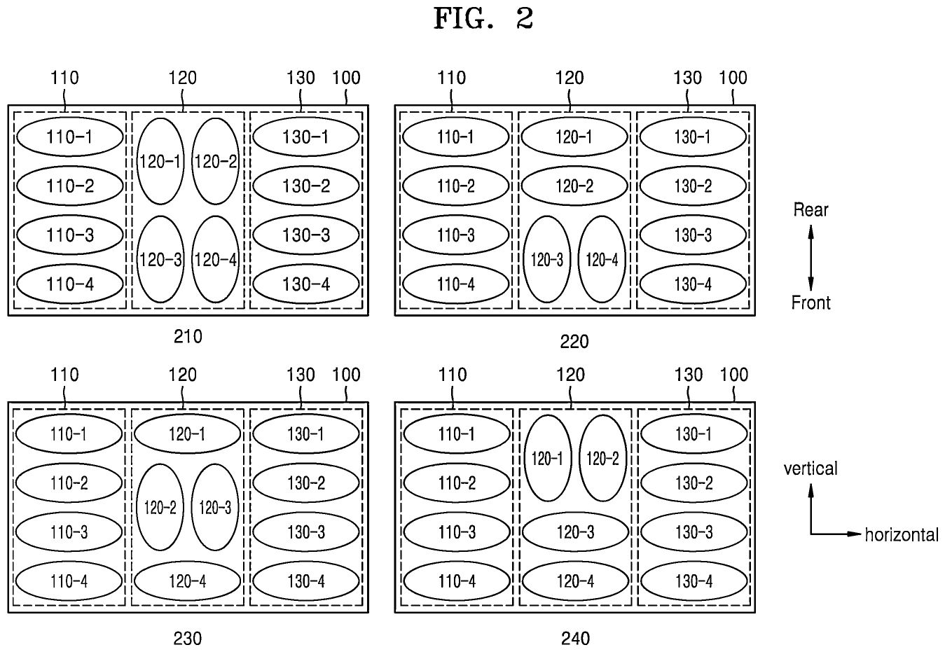

A structure of the burners included in the cooking device 100 according to an embodiment of the present disclosure is not limited to that shown in FIG. 1. For example, the burners included in the cooking device 100 according to an embodiment of the present disclosure may be configured in various forms, as shown in FIGS. 2, 3, 4, and 5.

FIG. 2 illustrates a structure of burners included in the cooking device 100 when the first power unit 110, the second power unit 120, and the third power unit 130 are included in the cooking device 100 according to an embodiment of the present disclosure.

Referring to a reference numeral 210 of FIG. 2, the first to fourth burners 110-1 to 110-4 of which the powers are controlled by the first power unit 110 are horizontally arranged in oval shapes. The first and second burners 120-1 and 120-2 of which the powers are controlled by the second power unit 120 are vertically arranged in oval shapes, at locations adjacent to the rear of the cooking device 100. The third and fourth burners 120-3 and 120-4 of which the powers are controlled by the second power unit 120 are arranged vertically in oval shapes, at locations adjacent to the front of the cooking device 100. The first to fourth burners 130-1 to 130-4 controlled by the third power unit 130 are horizontally arranged in oval shapes.

Referring to a reference numeral 220 of FIG. 2, the first to fourth burners 110-1 to 110-4 of which the powers are controlled by the first power unit 110 are horizontally arranged in oval shapes. The first and second burners 120-1 and 120-2 of which the powers are controlled by the second power unit 120 are arranged horizontally in oval shapes, at locations adjacent to the rear of the cooking device 100. The third and fourth burners 120-3 and 120-4 of which the powers are controlled by the second power unit 120 are arranged vertically in oval shapes, at locations adjacent to the front of the cooking device 100. The first to fourth burners 130-1 to 130-4 of which the powers are controlled by the third power unit 130 are vertically arranged in oval shapes.

Referring to a reference numeral 230 of FIG. 2, the first to fourth burners 110-1 to 110-4 of which the powers are controlled by the first power unit 110 are horizontally arranged in oval shapes. The first burner 120-1 of which the power is controlled by the second power unit 120 is arranged horizontally in an oval shape, at a location adjacent to the rear of the cooking device 100. The second and third burners 120-2 and 120-3 of which the powers are controlled by the second power unit 120 are arranged vertically in oval shapes, at the center of the cooking device 100. The fourth burner 120-4 of which the power is controlled by the second power unit 120 is arranged horizontally in an oval shape, at a location adjacent to the front of the cooking device 100. The first to fourth burners 130-1 to 130-4 of which the powers are controlled by the third power unit 130 are vertically arranged in oval shapes.

Referring to a reference numeral 240 of FIG. 2, the first to fourth burners 110-1 to 110-4 of which the powers are controlled by the first power unit 110 are horizontally arranged in oval shapes. The first and second burners 120-1 and 120-2 of which the powers are controlled by the second power unit 120 are arranged vertically in oval shapes, at locations adjacent to the rear of the cooking device 100. The third and fourth burners 120-3 and 120-4 of which the powers are controlled by the second power unit 120 are arranged horizontally in oval shapes, at locations adjacent to the front of the cooking device 100. The first to fourth burners 130-1 to 130-4 of which the powers are controlled by the third power unit 130 are horizontally arranged in oval shapes.

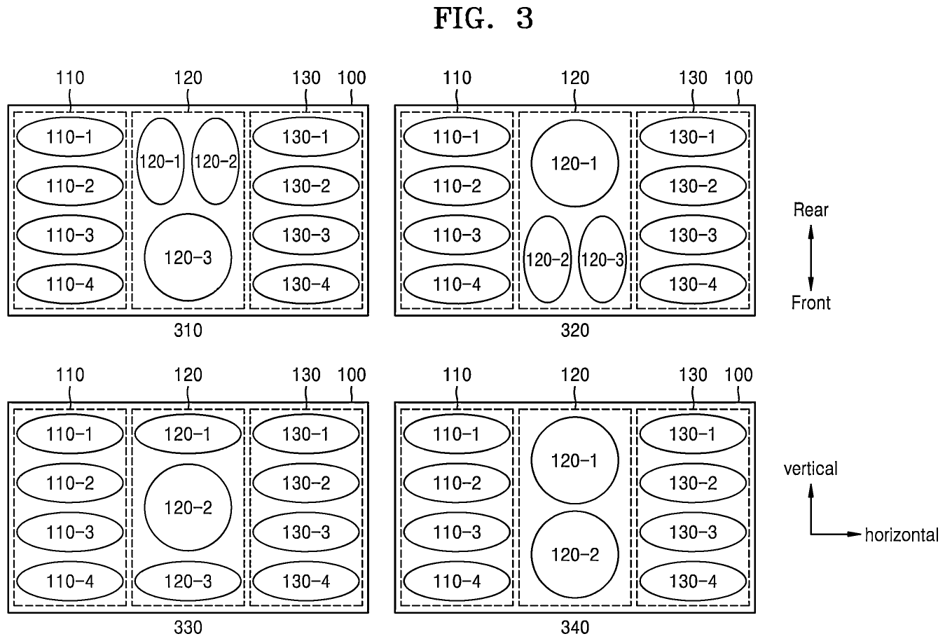

FIG. 3 illustrates a structure of burners included in the cooking device 100 when the first power unit 110, the second power unit 120, and the third power unit 130 are included in the cooking device 100 according to an embodiment of the present disclosure.

Referring to a reference numeral 310 of FIG. 3, the first to fourth burners 110-1 to 110-4 of which the powers are controlled by the first power unit 110 are horizontally arranged in oval shapes. The first and second burners 120-1 and 120-2 of which the powers are controlled by the second power unit 120 are arranged vertically in oval shapes, at locations adjacent to the rear of the cooking device 100. The third burner 120-3 of which the power is controlled by the second power unit 120 is arranged in a circular shape, at a location adjacent to the front of the cooking device 100. The first to fourth burners 130-1 to 130-4 of which the powers are controlled by the third power unit 130 are horizontally arranged in oval shapes.

Referring to a reference numeral 320 of FIG. 2, the first to fourth burners 110-1 to 110-4 of which the powers are controlled by the first power unit 110 are horizontally arranged in oval shapes. The first burner 120-1 of which the power is controlled by the second power unit 120 is arranged in a circular shape, at a location adjacent to the rear of the cooking device 100. The second and third burners 120-2 and 120-3 of which the powers are controlled by the second power unit 120 are arranged vertically in oval shapes, at locations adjacent to the front of the cooking device 100. The first to fourth burners 130-1 to 130-4 of which the powers are controlled by the third power unit 130 are horizontally arranged in oval shapes.

Referring to a reference numeral 330 of FIG. 3, the first to fourth burners 110-1 to 110-4 of which the powers are controlled by the first power unit 110 are horizontally arranged in oval shapes. The first burner 120-1 of which the power is controlled by the second power unit 120 is arranged horizontally in an oval shape, at a location adjacent to the rear of the cooking device 100. The second burner 120-2 of which the power is controlled by the second power unit 120 is arranged in a circular shape, at the center of the cooking device 100. The third burner 120-3 of which the power is controlled by the second power unit 120 is arranged horizontally in an oval shape, at a location adjacent to the front of the cooking device 100. The first to fourth burners 130-1 to 130-4 of which the powers are controlled by the third power unit 130 are horizontally arranged in oval shapes.

Referring to a reference numeral 340 of FIG. 3, the first to fourth burners 110-1 to 110-4 of which the powers are controlled by the first power unit 110 are horizontally arranged in oval shapes. The first burner 120-1 of which the power is controlled by the second power unit 120 is arranged in a circular shape, at a location adjacent to the rear of the cooking device 100. The second burner 120-2 of which the power is controlled by the second power unit 120 is arranged in a circular shape, at a location adjacent to the front of the cooking device 100. The first to fourth burners 130-1 to 130-4 of which the powers are controlled by the third power unit 130 are horizontally arranged in oval shapes.

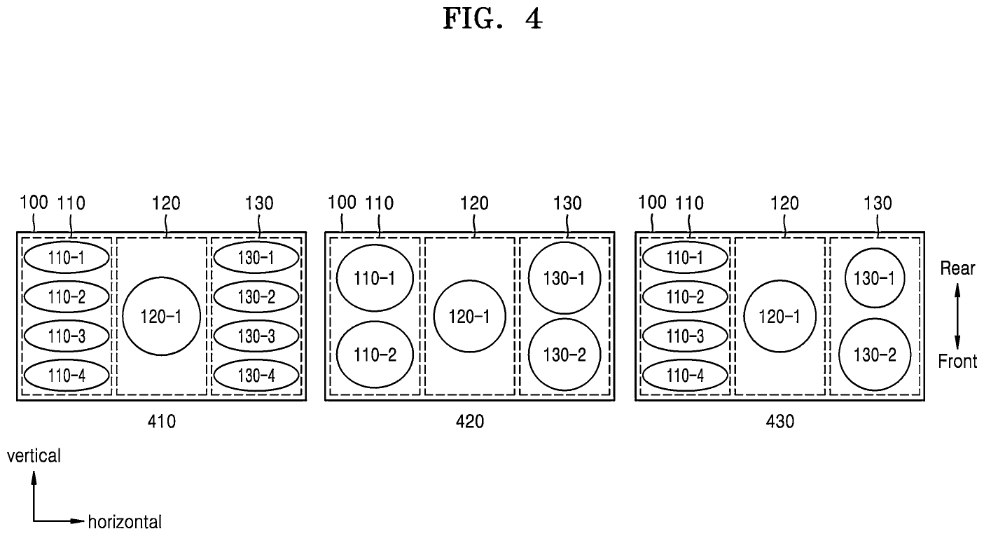

FIG. 4 illustrates a structure of burners included in the cooking device 100 when the first power unit 110, the second power unit 120, and the third power unit 130 are included in the cooking device 100 according to an embodiment of the present disclosure.

Referring to a reference numeral 410 of FIG. 4, the first to fourth burners 110-1 to 110-4 of which the powers are controlled by the first power unit 110 are horizontally arranged in oval shapes. The first burner 120-1 of which the power is controlled by the second power unit 120 is arranged in a circular shape, at the center of the cooking device 100. The first to fourth burners 130-1 to 130-4 of which the powers are controlled by the third power unit 130 are vertically arranged in oval shapes.

Referring to a reference numeral 420 of FIG. 4, the first burner 110-1 of which the power is controlled by the first power unit 110 is arranged in a circular shape, at a location adjacent to the rear of the cooking device 100. The second burner 110-2 of which the power is controlled by the first power unit 110 is arranged in a circular shape, at a location adjacent to the front of the cooking device 100. The first burner 120-1 of which the power is controlled by the second power unit 120 is arranged in a circular shape, at the center of the cooking device 100. The first burner 130-1 of which the power is controlled by the third power unit 130 is arranged in a circular shape, at a location adjacent to the rear of the cooking device 100. The second burner 130-2 of which the power is controlled by the third power unit 130 is arranged in a circular shape, at a location adjacent to the front of the cooking device 100.

Referring to a reference numeral 430 of FIG. 4, the first to fourth burners 110-1 to 110-4 of which the powers are controlled by the first power unit 110 are horizontally arranged in oval shapes. The first burner 120-1 of which the power is controlled by the second power unit 120 is arranged in a circular shape, at the center of the cooking device 100. The first burner 130-1 of which the power is controlled by the third power unit 130 is arranged in a circular shape, at a location adjacent to the rear of the cooking device 100. The second burner 130-2 is arranged in a circular shape, at a location adjacent to the front of the cooking device 100. The sizes of the first burner 130-1 and second burner 130-2 may be different from each other.

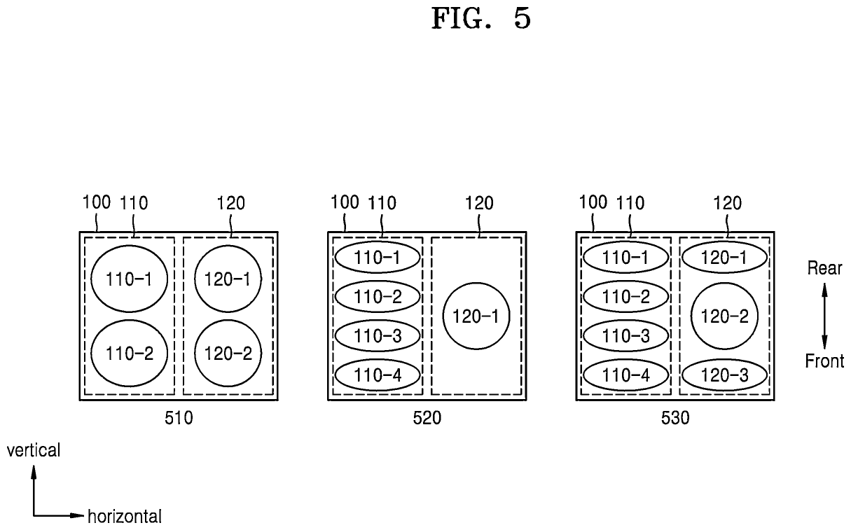

FIG. 5 illustrates a structure of burners included in the cooking device 100 when the first power unit 110 and the second power unit 120 are included in the cooking device 100 according to an embodiment of the present disclosure.

Referring to a reference numeral 510 of FIG. 5, the first burner 110-1 of which the power is controlled by the first power unit 110 is arranged in a circular shape, at a location adjacent to the rear of the cooking device 100. The second burner 110-2 of which the power is controlled by the first power unit 110 is arranged in a circular shape, at a location adjacent to the front of the cooking device 100. The first burner 120-1 of which the power is controlled by the second power unit 120 is arranged in a circular shape, at a location adjacent to the rear of the cooking device 100. The second burner 120-2 of which the power is controlled by the second power unit 120 is arranged in a circular shape, at a location adjacent to the front of the cooking device 100.

Referring to a reference numeral 520 of FIG. 5, the first to fourth burners 110-1 to 110-4 of which the powers are controlled by the first power unit 110 are horizontally arranged in oval shapes. The first burner 120-1 of which the power is controlled by the second power unit 120 is arranged in a circular shape, at the center of the cooking device 100.

Referring to a reference numeral 530 of FIG. 5, the first to fourth burners 110-1 to 110-4 of which the powers are controlled by the first power unit 110 are horizontally arranged in oval shapes. The first burner 120-1 of which the power is controlled by the second power unit 120 is arranged horizontally in an oval shape, at a location adjacent to the rear of the cooking device 100. The second burner 120-2 of which the power is controlled by the second power unit 120 is arranged in a circular shape, at the center of the cooking device 100. The third burner 120-3 of which the power is controlled by the second power unit 120 is arranged horizontally in an oval shape, at a location adjacent to the front of the cooking device 100.

Same reference numerals are provided to the burners controlled by the first to third power units 110 to 130, despite that the burners have different shapes, different sizes, and different arranged locations in FIGS. 2, 3, 4, and 5, for convenience of description. Thus, maximum powers of the burners controlled by the first to third power units 110 to 130 may vary depending on locations, shapes, and sizes of the burners.

Also, the number of power units included in the cooking device 100 according to an embodiment of the present disclosure, the number of burners of which powers are controlled by each power unit, shapes of the burners, and an arrangement of the burners are not limited to those shown in FIGS. 1, 2, 3, 4, and 5. A structure of burners and the number of power units may be determined according to a width of a cooking plate of the cooking device 100 according to an embodiment of the present disclosure. For example, when the width of the cooking plate of the cooking device 100 is greater than a width shown in FIG. 2, the cooking device 100 may include a greater number of burners and a greater number of power units than those shown in FIG. 2. When the width of the cooking plate of the cooking device 100 is less than a width shown in FIG. 5, the cooking device 100 may include a smaller number of burners and a smaller number of power units than those shown in FIG. 5.

FIG. 6 is a block diagram for describing functions of the cooking device 100, according to an embodiment of the present disclosure.

Referring to FIG. 6, the cooking device 100 according to an embodiment of the present disclosure includes the user interface 610, a memory 620, a main processor 630, the first power unit 110 configured to control the powers of the first to fourth burners 110-1 to 110-4, and the second power unit 120 configured to control the powers of the first to fourth burners 120-1 to 120-4.

The user interface 610 may receive a control command from a user and display, to the user, operation information of the cooking device 100. The user interface 610 may be located on the cooking plate of the cooking device 100 as shown in FIG. 1, but is not limited thereto. The user interface 610 may be arranged in various forms on a front surface or side surface of the cooking device 100 and/or a top of the cooking plate.

The user interface 610 may include a touch screen 611 displaying information or content related to an operation of the cooking device 100 and an input button 612 receiving the control command from the user. The touch screen 611 may output, in the form of a notification message, information about operating states of the first power unit 110 and second power unit 120, which is transmitted from the main processor 630. The information about the operating states of the first power unit 110 and the second power unit 120 may include information about a state in which operations of the first power unit 110 and the second power unit 120 are controlled together. The information about the operating states of the first power unit 110 and the second power unit 120 may include, when the operations of the first power unit 110 and the second power unit 120 are not controlled together, information about reasons thereof. The information about the reasons may include, for example, information indicating that a difference between the operating frequency of the first power unit 110 and the operating frequency of the second power unit is a threshold value or greater.

The touch screen 611 may display information about a burner being currently operated. For example, as shown by a reference numeral 720 of FIG. 7, information indicating that the first burner 110-1 and the second burner 110-2, of which the powers are controlled by the first power unit 110, and the first burner 120-1 and the second burner 120-2, of which the powers are controlled by the second power unit 120, are being operated may be displayed. FIG. 7 illustrates operations of burners included in the cooking device 100, according to an embodiment of the present disclosure.

The touch screen 611 may output, in the form of a notification message, a result of determining whether the first power unit 110 and the second power unit 120 are operable together, based on the difference between the operating frequency of the first power unit 110 and the operating frequency of the second power unit 120. Also, the touch screen 611 may output, in the form of a notification message, information about a result of determining whether burners corresponding to a button controlled when a burner selecting button included in the input button 612 is controlled are operable together. Information or a notification message output on the touch screen 611 may be provided by, for example, the main processor 630 reading data stored in the memory 620, but is not limited thereto.

The input button 612 may include a plurality of buttons for receiving a control command from the user and outputting an electrical signal corresponding to the received control command to the main processor 630. For example, the input button 612 may include an operation button for receiving a power on/off command for the cooking device 100 and a button for increasing or decreasing a power level of the cooking device 100. The power level of the cooking device 100 may indicate strength of a magnetic field and/or an electromagnetic field output by the cooking device 100.

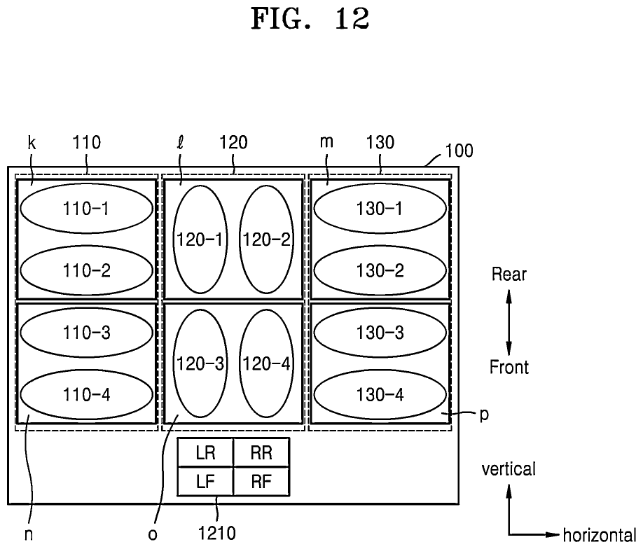

Also, the input button 612 may include at least one button for selecting burners to be operated together, from among the first to fourth burners 110-1 to 110-4 and the first to fourth burners 120-1 to 120-4. The at least one button will be described in more detail below with reference to buttons 1210 shown in FIG. 12. The input button 612 may be configured as a touch type or a toggle switch type, but the type of the input button 612 is not limited thereto.

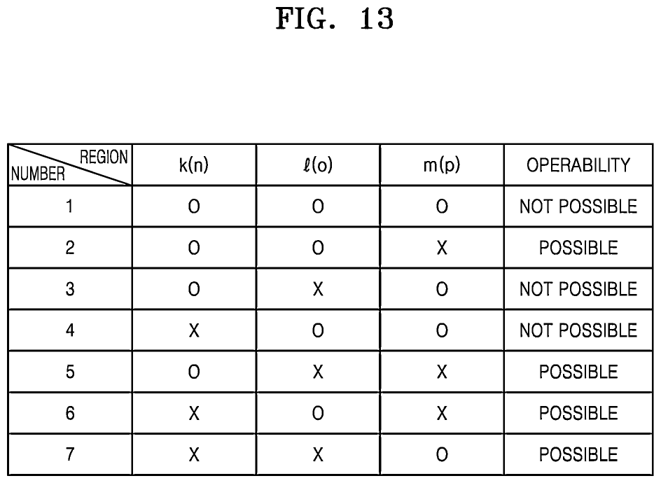

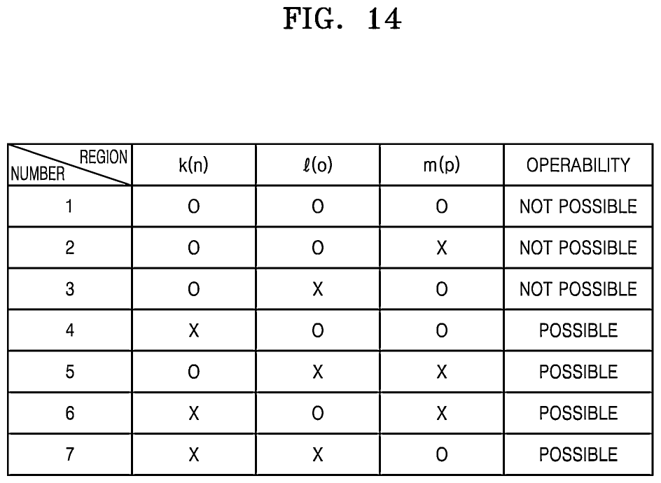

The memory 620 may store a program and data for performing operations of the main processor 630, according to an embodiment of the present disclosure. The memory 620 may store information about burners that are operable together from among the first to fourth burners 110-1 to 110-4 and the first to fourth burners 120-1 to 120-4. The information about burners will be described in detail below with reference to FIGS. 13 and 14.

The memory 620 may include a non-volatile semiconductor memory device or a non-volatile memory, such as read-only memory (ROM), high-speed random access memory (RAM), magnetic disk storage device, or a flash memory device. For example, the memory 620 may use, as a semiconductor memory device, a secure digital (SD) memory card, a secure digital high capacity (SDHC) memory card, a mini SD memory card, a mini SDHC memory card, a trans flash (TF) memory card, a micro SD memory card, a micro SDHC memory card, a memory stick, a compact flash (CF), a multi-media card (MMC), MMC micro, or extreme digital (XD) card. The memory 620 may also be referred to as a storage. Also, the memory 620 may include a network attached storage device accessed through a network. The memory 620 is not limited thereto.

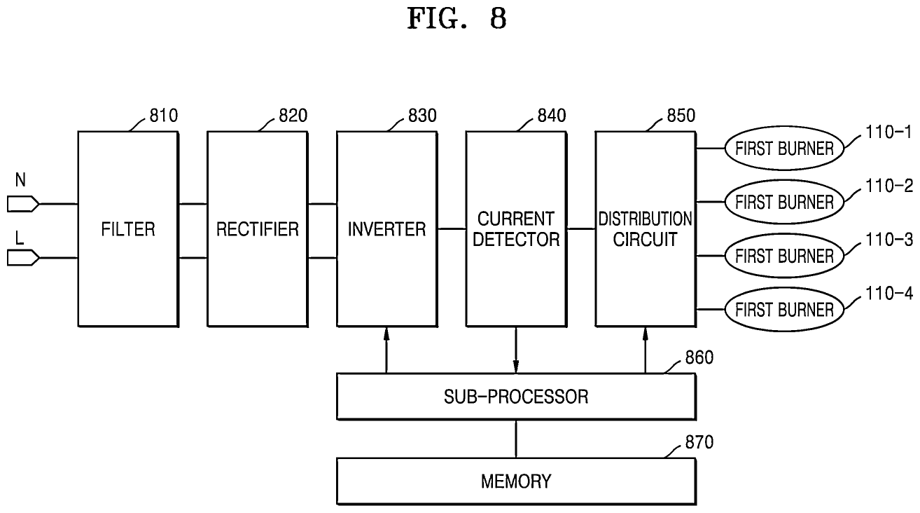

The main processor 630 may control general operations of the cooking device 100 by executing a program stored in the memory 620. The main processor 630 may read and use data stored in the memory 620. The main processor 630 may update the data stored in the memory 620. The main processor 630 may store (or write) new data in the memory 620. The main processor 630 may be configured as a chip, such as a microprocessor. The main processor 630 may be referred to as a processor, but is specified as a main processor so as to be distinguished from a processor (or a sub-processor 860) included in the first power unit 110 and second power unit 120, shown in FIG. 8 described below. The main processor 630 may be configured to include the memory 620.

The main processor 630 may control operations of the first power unit 110 and the second power unit 120, according to an input (burner selection, power setting, or the like) received through the input button 612.

For example, upon identifying that a container overlaps a portion of the first to fourth burners 110-1 to 110-4 of the first power unit 110 and a portion of the first to fourth burners 120-1 to 120-4 of the second power unit 120, the main processor 630 may determine one operating frequency, based on the operating frequency of the first power unit 110 and the operating frequency of the second power unit 120.

The main processor 630 may detect a burner overlapped with the container, based on a signal obtained by detecting currents and phase angles of the first to fourth burners 110-1 to 110-4, transmitted from the first power unit 110, and a signal obtained by detecting currents and phase angles of the first to fourth burners 120-1 to 120-4, transmitted from the second power unit 120. For example, as shown in the reference numeral 720 of FIG. 7, the main processor 630 may identify that burners overlapped with the container are the first and second burners 110-1 and 110-2 and the first and second burners 120-1 and 120-2, based on signals obtained by detecting phase angles and currents of burners, transmitted from the first power unit 110 and the second power unit 120.

When burners overlapped with the container are identified as the first and second burners 110-1 and 110-2 and the first and second burners 120-1 and 120-2, the main processor 630 determines one operating frequency, based on the operating frequency of the first power unit 110, provided from the first power unit 110, and the operating frequency of the second power unit 120, provided from the second power unit 120.

For example, when the operating frequency of the first power unit 110 is 25 kHz and the operating frequency of the second power unit 120 is 35 kHz, the main processor 630 may determine, as the operating frequency of the first power unit 110 and the second power unit 120, one of 25 kHz that is the operating frequency of the first power unit 110, 35 kHz that is the operating frequency of the second power unit 120, and 30 kHz that is an intermediate frequency between the operating frequency of the first power unit 110 and the operating frequency of the second power unit 120.

For example, the main processor 630 may determine 25 kHz that is the operating frequency of the first power unit 110 as the operating frequency of the first power unit 110 and second power unit 120. The main processor 630 may determine 35 kHz that is the operating frequency of the second power unit 120 as the operating frequency of the first power unit 110 and second power unit 120. The main processor 630 may determine 30 kHz that is the intermediate frequency between the operating frequency of the first power unit 110 and the operating frequency of the second power unit 120 as the operating frequency of the first power unit 110 and second power unit 120.

When determining the operating frequency of the first power unit 110 and the second power unit 120, the main processor 630 may determine, as the operating frequency, one of a lowest frequency (e.g., 25 kHz), an intermediate frequency (30 kHz), and a highest frequency (35 kHz), according to a set power level. When the operating frequency of the first power unit 110 and the second power unit 120 is determined as the lowest frequency, the first to fourth burners 110-1 to 110-4 and the first to fourth burners 120-1 to 120-4 operate with a high power value. When the operating frequency of the first power unit 110 and the second power unit 120 is determined as the highest frequency, the first to fourth burners 110-1 to 110-4 and the first to fourth burners 120-1 to 120-4 operate with a low power value.

The operating frequency determined by the main processor 630 is for operating the first power unit 110 and the second power unit 120 together and thus may be referred to as a common frequency or a synchronization frequency. The synchronization frequency denotes a frequency obtained by matching the operating frequency of the first power unit 110 and the operating frequency of the second power unit 120 to a same frequency. A method by which the main processor 630 determines the operating frequencies of the first power unit 110 and second power unit 120 to one operating frequency is not limited thereto.

When the operating frequency for operating the first power unit 110 and the second power unit 120 together is determined, the main processor 630 may transmit the determined operating frequency to the first power unit 110 and the second power unit 120 to control operations of the first power unit 110 and the second power unit 120.

Accordingly, compared to when only the first and second burners 110-1 and 110-2 of the first power unit 110 are operated in the prior art as shown by a reference numeral 710 of FIG. 7, the first and second burners 110-1 and 110-2 of the first power unit 110 and the first and second burners 120-1 and 120-2 of the second power unit 120 are operated together as shown by the reference numeral 720 to heat a container, and thus, the container may quickly and uniformly cook an object to be cooked. FIG. 7 illustrates the operations of the burners included in the cooking device 100, according to an embodiment of the present disclosure.

When the difference between the operating frequency of the first power unit 110 and the operating frequency of the second power unit 120 is the threshold value or greater, the main processor 630 may stop an operation of one of the first power unit 110 and the second power unit 120 or control one of the first power unit 110 and the second power unit 120 to not operate. The threshold value may be set to, for example, 20 kHz, considering an audible frequency band, but is not limited thereto.

When the difference between the operating frequency of the first power unit 110 and the operating frequency of the second power unit 120 is less than the threshold value, the main processor 630 may determine the operating frequencies of the first power unit 110 and the second power unit 120 to be one operating frequency as described above.

The main processor 630 may generate a signal for controlling operations of the first power unit 110 and the second power unit 120, according to an input (burner selection, power setting, or the like) received through the input button 612.

The main processor 630 may transmit information about an operating state of the cooking device 100, information about a condition set in the cooking device 100 according to an input received through the input button 612, and the like, to the touch screen 611 and display same on the touch screen 611.

The first power unit 110 and the second power unit 120 may be configured as shown in FIG. 8. FIG. 8 is a block diagram for describing functions of a power unit included in the cooking device 100 according to an embodiment of the present disclosure. Hereinafter, for convenience of description, a block diagram of the first power unit 110 is described, but the descriptions below may also be applied to the second power unit 120 and the third power unit 130 shown in FIGS. 9 and 11 that will be described below.

Referring to FIG. 8, the first power unit 110 includes a filter 810, a rectifier 820, an inverter 830, a current detector 840, a distribution circuit 850, the sub-processor 860, and a memory 870, but a configuration of the first power unit 110 is not limited by FIG. 8.

The filter 810 removes high-frequency noise (e.g., harmonic waves of alternating current (AC) power) included in the AC power supplied from the outside, and passes an AC voltage and an AC current of a pre-determined frequency (e.g., 50 Hz or 60 Hz). The filter 810 may be configured as an electromagnetic interference (EMI) filter, but is not limited thereto. The filter 810 may include the inductor L and the capacitor C. The inductor L may block the passage of the high-frequency noise and the capacitor C may bypass the high-frequency noise to an external power source (AC). The filter 810 transmits, to the rectifier 820, the AC power from which the high-frequency noise has been removed.

The rectifier 820 converts the applied AC power into direct current (DC) power. The rectifier 820 converts the AC voltage of which a magnitude and polarity (positive voltage or negative voltage) change over time into a DC voltage of which a magnitude and polarity are constant. The rectifier 820 may include a bridge diode. For example, the rectifier 820 may include four diodes. The four diodes may form diode pairs in which two diodes are connected in series, and two diode pairs may be connected in parallel. The bridge diode may convert the AC voltage of which polarity changes over time to a positive voltage of which polarity is constant, and convert an AC current of which a direction changes over time to a positive current of which a direction is constant. Also, the rectifier 820 may include a DC link capacitor. The DC link capacitor may convert a positive voltage of which magnitude changes over time to a DC voltage having a constant magnitude. The DC voltage output from the rectifier 820 is transmitted to the inverter 830.

The inverter 830 includes two switching circuits configured to supply or block a driving current to the first to fourth burners 110-1 to 110-4, and a resonant circuit configured to generate resonance together with the first to fourth burners 110-1 to 110-4. The two switching circuits are alternately turned on or off according to a driving control signal transmitted from the sub-processor 860. The two switching circuits being alternately turned on or ff indicate that when one switch among the two switching circuits is turned on, the other switch is turned off. According to turn-on or turn-off of the two switching circuits, the driving current may flow towards the first to fourth burners 110-1 to 110-4 or the driving current may flow from the first to fourth burners 110-1 to 110-4 through the two switching circuits. The two switching circuits are turned on or off according to an operating frequency applied to the first power unit 110. For example, when the operating frequency applied to the first power unit 110 is 25 kHz, the two switching circuits are turned on or off by the applied 25 kHz. For example, when the operating frequency applied to the first power unit 110 is 36 kHz, the two switching circuits are turned on or off by the applied 36 kHz. For example, when the operating frequency applied to the first power unit 110 is 70 kHz, the two switching circuits are turned on or off by the applied 70 kHz.

The two switching circuits may include a semiconductor device switch with a quick response speed. For example, the two switching circuits may include a bipolar junction transistor (BJT), a metal-oxide-semiconductor field effect transistor (MOSFET), an insulated gate bipolar transistor (IGBT), or a thyristor.

The resonant circuit may include a plurality of resonant capacitors in series. When the two switching circuits are turned on or off, a current may be output to the first to fourth burners 110-1 to 110-4 through the plurality of resonant capacitors or a current may be input from the first to fourth burners 110-1 to 110-4 through the plurality of resonant capacitors.

As such, an AC current of which a magnitude and direction of the current flowing through the first to fourth burners 110-1 to 110-4 change according to turn-on or turn-off of the two switching circuit included in the inverter 830 may be provided. Also, when a switching cycle of the two switching circuits is increased (when an operating frequency is decreased), a current supplied to the first to fourth burners 110-1 to 110-4 is increased, and thus, strength of a magnetic field output by the first to fourth burners 110-1 to 110-4 (power of the cooking device 100) is increased.

The current detector 840 detects a phase angle and current flowing from the inverter 830 to the first to fourth burners 110-1 to 110-4 and provides same to the sub-processor 860. Accordingly, the sub-processor 860 may recognize a location of a container overlapping the first to fourth burners 110-1 to 110-4. The sub-processor 860 transmits the recognized location of the container to the main processor 630.

The distribution circuit 850 may include a plurality of switches passing or blocking a current supplied to the first to fourth burners 110-1 to 110-4. The plurality of switches included in the distribution circuit 850 are turned on or off by a distribution control signal transmitted from the sub-processor 860.

The sub-processor 860 may execute a program stored in the memory 870 and control an operation of the first power unit 110 by using data stored in the memory 870. The sub-processor 860 may control a turn-on or turn-off operation of the two switching circuits included in the inverter 830 by using an operating frequency received from the main processor 630.

The sub-processor 860 may read data stored in the memory 870 and use the same, or store data in the memory 870. For example, the sub-processor 860 may temporarily store, in the memory 870, and manage information about power levels of the first to fourth burners 110-1 to 110-4 or information about operating states of the first to fourth burners 110-1 to 110-4.

The sub-processor 860 may be configured to include the memory 870. The memory 870 may include same components as the memory 620 of FIG. 6. The memory 870 may store a program and data for performing operations of the sub-processor 860, according to an embodiment of the present disclosure. The memory 870 may store information about the first to fourth burners 110-1 to 110-4. The information about the first to fourth burners 110-1 to 110-4, stored in the memory 870, may include, for example, information about a phase angle and current flowing through the first to fourth burners 110-1 to 110-4 and information about the operating frequency of the first power unit 110, but is not limited thereto.

The memory 870 may include a non-volatile semiconductor memory device or a non-volatile memory, such as ROM, high-speed RAM, magnetic disk storage device, or a flash memory device. For example, the memory 870 may use, as a semiconductor memory device, an SD memory card, an SDHC memory card, a mini SD memory card, a mini SDHC memory card, a TF memory card, a micro SD memory card, a micro SDHC memory card, a memory stick, a CF, an MMC, MMC micro, or XD card. The memory 870 may also be referred to as a storage.

The cooking device 100 shown in FIG. 6 may set the operating frequencies of the first power unit 110 and the second power unit 120 to be the same even when different containers are placed on the first power unit 110 and the second power unit 120. However, when it is determined that the difference between the operating frequency of the first power unit 110 and the operating frequency of the second power unit 120 is the threshold value or greater (e.g., when a difference between power levels of burners are big), the main processor 630 determines that the operating frequency of the first power unit 110 and the operating frequency of the second power unit 120 is unable to be determined to be one operating frequency. Accordingly, the main processor 630 stops an operation of one power unit from among the first power unit 110 and the second power unit 120.

The main processor 630 outputs a notification message about the power unit that has been stopped, through the touch screen 611 of the user interface 610, for the user to perceive the same. For example, a guidance message may be output to set the power level of the second power unit 120 to be the same as the power level of the first power unit 110 because an operation of the second power unit 120 has been stopped as noise may be generated when two power units are simultaneously operated. The user interface 610 may further include an audio output unit to output the guidance message in speech.

FIG. 9 is a block diagram for describing functions of the cooking device 100, according to an embodiment of the present disclosure.

In the cooking device 100 shown in FIG. 9, a main processor 913 included in the user interface 910 may determine an operating frequency of the first to third power units 110 to 130 and control the first to third power units 110 to 130 to operate together by using the determined operating frequency. In the cooking device 100 of FIG. 9, the main processor 913 included in the user interface 910 may determine an operating frequency of at least two power units from among the first to third power units 110 to 130 and control the two power units to operate together by using the determined operating frequency. In the cooking device 100 of FIG. 9, the main processor 913 included in the user interface 910 may control one of the first to third power units 110 to 130 to operate.

The cooking device 100 of FIG. 9 includes the user interface 910, a memory 915, the first power unit 110, the second power unit 120, the third power unit 130, the first to fourth burners 110-1 to 110-4 of which the powers are controlled by the first power unit 110, the first to fourth burners 120-1 to 120-4 of which the powers are controlled by the second power unit 120, and the first to fourth burners 130-1 to 130-4 of which the powers are controlled by the third power unit 130, but a configuration of the cooking device 100 according to an embodiment of the present disclosure is not limited by that shown in FIG. 9.

The user interface 910 includes a touch screen 911, an input button 912, and the main processor 913, but a configuration of the user interface 910 according to an embodiment of the present disclosure is not limited thereto.

The touch screen 911 included in the user interface 910 may operate by being configured in a same manner as the touch screen 611 of FIG. 6. The touch screen 911 may display information about a burner being currently operated. For example, as shown by a reference numeral 1020 of FIG. 10, information indicating that the first burner 110-1 and the second burner 110-2, of which the powers are controlled by the first power unit 110, and the first burner 120-1 and the second burner 120-2, of which the powers are controlled by the second power unit 120, are being operated may be displayed. FIG. 10 illustrates the operations of the burners included in the cooking device 100, according to an embodiment of the present disclosure.

The touch screen 911 may output, in the form of a notification message, a result of determining whether the first power unit 110 and the second power unit 120 are operable together, based on the difference between the operating frequency of the first power unit 110 and the operating frequency of the second power unit 120. The touch screen 911 may output, in the form of a notification message, a result of determining whether the second power unit 120 and the third power unit 130 are operable together, based on the difference between the operating frequency of the second power unit 120 and the operating frequency of the third power unit 130. The touch screen 911 may output, in the form of a notification message, a result of determining whether the first power unit 110, the second power unit 120, and the third power unit 130 are operable together, based on a difference between the operating frequency of the first power unit 110, the operating frequency of the second power unit 120, and the operating frequency of the third power unit 130.

Also, the touch screen 911 may output, in the form of a notification message, information about a result of determining whether burners corresponding to a button controlled when a burner selecting button included in the input button 912 is controlled are operable together. Information or a notification message output on the touch screen 911 may be provided by, for example, the main processor 913 reading data stored in the memory 915, but is not limited thereto.

The cooking device 100 of FIG. 9 includes the first to third power units 110 to 130, and thus, the touch screen 911 includes functions related to the third power unit 130. The functions related to the third power unit 130, included in the touch screen 911, may include at least one of, for example, a function of controlling a power level of the third power unit 130, a function of notifying information about an operating state of the third power unit 130, a function of controlling power levels of the first to fourth burners 130-1 to 130-4 of which powers are controlled by the third power unit 130, or a function of notifying information about operating states or power levels of the first to fourth burners 130-1 to 130-4 of which powers are controlled by the third power unit 130.

The input button 912 may operate by being configured in a same manner as the input button 612 of FIG. 6. The input button 912 may include a plurality of buttons for receiving a control command from the user and outputting an electrical signal corresponding to the received control command to the main processor 913. For example, the input button 912 may include an operation button for receiving a power on/off command for the cooking device 100 and a button for increasing or decreasing a power level of the cooking device 100. The power level of the cooking device 100 may indicate strength of a magnetic field and/or an electromagnetic field output by the cooking device 100.

Also, the input button 912 may include at least one button for selecting burners to be operated together, from among the first to fourth burners 110-1 to 110-4, the first to fourth burners 120-1 to 120-4, and the first to fourth burners 130-1 to 130-4. The at least one button will be described in more detail below with reference to buttons 1210 shown in FIG. 12. The input button 912 may be configured as a touch type or a toggle switch type, but the type of the input button 912 is not limited thereto.

The cooking device 100 of FIG. 9 includes the first to third power units 110 to 130, and thus, the input button 912 may include a button for controlling a function related to the third power unit 130.

The main processor 913 may be operated by being configured in a same manner as the main processor 630 of FIG. 6. The main processor 913 may be configured to include the memory 915.

The main processor 913 may control general operations of the cooking device 100 by executing a program stored in the memory 915. The main processor 913 may read and use data stored in the memory 915. The main processor 913 may update the data stored in the memory 915. The main processor 913 may store (or write) new data in the memory 915. The main processor 913 may be configured as a chip, such as a microprocessor. The main processor 913 may be referred to as a processor but is referred to as a main processor to be distinguished from sub-processors 921, 931, and 941 included in the first power unit 110, the second power unit 120, and the third power unit 130.

The main processor 913 may control operations of the first power unit 110, the second power unit 120, and/or the third power unit 130 according to an input (burner selection, power (or power level) setting, or the like) received through the input button 912.

For example, upon identifying that a container overlaps a portion of the first to fourth burners 110-1 to 110-4 of the first power unit 110 and a portion of the first to fourth burners 120-1 to 120-4 of the second power unit 120, the main processor 913 may determine one operating frequency, based on the operating frequency of the first power unit 110 and the operating frequency of the second power unit 120.

For example, upon identifying that a container overlaps a portion of the first to fourth burners 120-1 to 120-4 of the second power unit 110 and a portion of the first to fourth burners 130-1 to 130-4 of the third power unit 130, the main processor 913 may determine one operating frequency, based on the operating frequency of the second power unit 120 and the operating frequency of the third power unit 130.

For example, upon identifying that a container overlaps a portion of the first to fourth burners 110-1 to 110-4 of the first power unit 110, a portion of the first to fourth burners 120-1 to 120-4 of the second power unit 120, and a portion of the first to fourth burners 130-1 to 130-4 of the third power unit 130, the main processor 913 may determine one operating frequency, based on the operating frequency of the first power unit 110, the operating frequency of the second power unit 120, and the operating frequency of the third power unit 130.

The main processor 913 may detect a burner overlapped with the container, based on a signal obtained by detecting currents and phase angles of the first to fourth burners 110-1 to 110-4, transmitted from the first power unit 110, a signal obtained by detecting currents and phase angles of the first to fourth burners 120-1 to 120-4, transmitted from the second power unit 120, and a signal obtained by detecting currents and phase angles of the first to fourth burners 130-1 to 130-4, transmitted from the third power unit 130.

For example, as shown in the reference numeral 1020 of FIG. 10, the main processor 913 may identify that burners overlapped with the container are the first and second burners 110-1 and 110-2 and the first and second burners 120-1 and 120-2, based on signals obtained by detecting phase angles and currents of burners, transmitted from the first power unit 110 and the second power unit 120. The signals obtained by detecting currents and phase angles are transmitted to the main processor 913 by the sub-processors 921, 931, and 941 respectively included in the first power unit 110, the second power unit 120, and the third power unit 130.

When burners overlapped with the container are identified as the first and second burners 110-1 and 110-2 and the first and second burners 120-1 and 120-2, the main processor 913 determines one operating frequency, based on the operating frequency of the first power unit 110, provided from the first power unit 110, and the operating frequency of the second power unit 120, provided from the second power unit 120.

For example, when the operating frequency of the first power unit 110 is 25 kHz and the operating frequency of the second power unit 120 is 35 kHz, the main processor 913 may determine, as the operating frequency of the first power unit 110 and the second power unit 120, one of 25 kHz that is the operating frequency of the first power unit 110, 35 kHz that is the operating frequency of the second power unit 120, and 30 kHz that is an intermediate frequency between the operating frequency of the first power unit 110 and the operating frequency of the second power unit 120.

For example, the main processor 913 may determine 25 kHz that is the operating frequency of the first power unit 110 as the operating frequency of the first power unit 110 and second power unit 120. The main processor 913 may determine 35 kHz that is the operating frequency of the second power unit 120 as the operating frequency of the first power unit 110 and second power unit 120. The main processor 913 may determine 30 KHz that is the intermediate frequency between the operating frequency of the first power unit 110 and the operating frequency of the second power unit 120 as the operating frequency of the first power unit 110 and second power unit 120.

When determining the operating frequency of the first power unit 110 and the second power unit 120, the main processor 913 may determine, as the operating frequency, one of a lowest frequency (e.g., 25 kHz), an intermediate frequency (30 kHz), and a highest frequency (35 kHz), according to a set power level. When the operating frequency of the first power unit 110 and the second power unit 120 is determined as the lowest frequency, the first to fourth burners 110-1 to 110-4 and the first to fourth burners 120-1 to 120-4 operate with a high power value. When the operating frequency of the first power unit 110 and the second power unit 120 is determined as the highest frequency, the first to fourth burners 110-1 to 110-4 and the first to fourth burners 120-1 to 120-4 operate with a low power value.

The operating frequency determined by the main processor 913 is for operating the first power unit 110 and the second power unit 120 together and thus may be referred to as a common frequency or a synchronization frequency. The synchronization frequency denotes a frequency obtained by matching the operating frequency of the first power unit 110 and the operating frequency of the second power unit 120 to a same frequency. A method by which the main processor 913 determines the operating frequencies of the first power unit 110 and second power unit 120 to one operating frequency is not limited thereto.

When the operating frequency for operating the first power unit 110 and the second power unit 120 together is determined, the main processor 913 may transmit the determined operating frequency to the first power unit 110 and the second power unit 120 to control operations of the first power unit 110 and the second power unit 120.

Accordingly, compared to when only the first and second burners 110-1 and 110-2 of the first power unit 110 are operated in the prior art as shown by a reference numeral 1010 of FIG. 10, the first and second burners 110-1 and 110-2 of the first power unit 110 and the first and second burners 120-1 and 120-2 of the second power unit 120 are operated together as shown by the reference numeral 1020 to heat a container, and thus, the container may quickly and uniformly cook an object to be cooked.

When the difference between the operating frequency of the first power unit 110 and the operating frequency of the second power unit 120 is the threshold value or greater, the main processor 913 may stop an operation of one of the first power unit 110 and the second power unit 120 or control one of the first power unit 110 and the second power unit 120 to not operate. The threshold value may be set to, for example, 20 kHz, considering an audible frequency band, but is not limited thereto.

When the difference between the operating frequency of the first power unit 110 and the operating frequency of the second power unit 120 is less than the threshold value, the main processor 913 may determine the operating frequencies of the first power unit 110 and the second power unit 120 to be one operating frequency as described above.

When burners overlapped with the container are identified as the first to fourth burners 120-1 to 120-4 and the first to fourth burners 130-1 to 130-4, the main processor 913 determines one operating frequency, based on the operating frequency of the second power unit 120, provided from the second power unit 120, and the operating frequency of the third power unit 130, provided from the third power unit 130.

For example, when the operating frequency of the second power unit 120 is 30 kHz and the operating frequency of the third power unit 130 is 40 kHz, the main processor 913 may determine, as the operating frequency of the second power unit 120 and the third power unit 130, one of 30 kHz that is the operating frequency of the second power unit 120, 40 kHz that is the operating frequency of the third power unit 130, and 35 kHz that is an intermediate frequency between the operating frequency of the second power unit 120 and the operating frequency of the third power unit 130.

For example, the main processor 913 may determine 30 kHz that is the operating frequency of the second power unit 120 as the operating frequency of the second power unit 120 and the third power unit 130. The main processor 913 may determine 40 kHz that is the operating frequency of the third power unit 130 as the operating frequency of the second power unit 120 and the third power unit 130. The main processor 913 may determine 35 kHz that is the intermediate frequency between the operating frequency of the second power unit 120 and the operating frequency of the third power unit 130 as the operating frequency of the second power unit 120 and the third power unit 130.

When determining the operating frequency of the second power unit 120 and the third power unit 130, the main processor 913 may determine, as the operating frequency, one of a lowest frequency (e.g., 30 kHz), an intermediate frequency (35 kHz), and a highest frequency (40 kHz), according to a set power level. When the operating frequency of the second power unit 120 and the third power unit 130 is determined as the lowest frequency, the first to fourth burners 120-1 to 120-4 and the first to fourth burners 130-1 to 130-4 operate with a high power value. When the operating frequency of the second power unit 120 and the third power unit 130 is determined as the highest frequency, the first to fourth burners 120-1 to 120-4 and the first to fourth burners 130-1 to 130-4 operate with a low power value.

The operating frequency determined by the main processor 913 is for operating the second power unit 120 and the third power unit 130 together and thus may be referred to as a common frequency or a synchronization frequency. The synchronization frequency denotes a frequency obtained by matching the operating frequency of the second power unit 120 and the operating frequency of the third power unit 130 to a same frequency. A method by which the main processor 913 determines the operating frequencies of the second power unit 120 and third power unit 130 to one operating frequency is not limited thereto.

When the operating frequency for operating the second power unit 120 and the third power unit 130 together is determined, the main processor 913 may transmit the determined operating frequency to the second power unit 120 and the third power unit 130 to control operations of the second power unit 120 and the third power unit 130. Accordingly, the first to fourth burners 120-1 to 120-4 of the second power unit 120 and the first to fourth burners 130-1 to 130-4 of the third power unit 130 operate together to heat a container, and thus, the container may quickly and uniformly cook an object to be cooked.

When the difference between the operating frequency of the second power unit 120 and the operating frequency of the third power unit 130 is the threshold value or greater, the main processor 913 may stop an operation of one of the second power unit 120 and the third power unit 130 or control one of the second power unit 120 and the third power unit 130 to not operate.

When the difference between the operating frequency of the second power unit 120 and the operating frequency of the third power unit 130 is less than the threshold value, the main processor 913 may determine the operating frequencies of the second power unit 120 and the third power unit 130 to be one operating frequency as described above.

When burners overlapped with the container are identified as the first to fourth burners 110-1 to 110-4, the first to fourth burners 120-1 to 120-4, and the first to fourth burners 130-1 to 130-4, the main processor 913 determines one operating frequency, based on the operating frequency of the first power unit 110, provided from the first power unit 110, the operating frequency of the second power unit 120, provided from the second power unit 120, and the operating frequency of the third power unit 130, provided from the third power unit 130.

For example, when the operating frequency of the first power unit 110 is 30 kHz, the operating frequency of the second power unit 120 is 30 kHz, and the operating frequency of the third power unit 130 is 40 kHz, the main processor 913 may determine, as the operating frequency of the first power unit 110, the second power unit 120, and the third power unit 130, one of 30 kHz that is the operating frequency of the first power unit 110 and second power unit 120, 40 KHz that is the operating frequency of the third power unit 130, and 35 kHz that is an intermediate frequency of the operating frequencies of the first power unit 110 and second power unit 120 and the operating frequency of the third power unit 130.

For example, the main processor 913 may determine 30 kHz that is the operating frequency of the first power unit 110 and second power unit 120, as the operating frequency of the first power unit 110, the second power unit 120, and the third power unit 130. The main processor 913 may determine 40 kHz that is the operating frequency of the third power unit 130 as the operating frequency of the first power unit 110, the second power unit 120, and the third power unit 130. The main processor 913 may determine 35 KHz that is the intermediate frequency of the operating frequencies of the first power unit 110 and second power unit 120 and the operating frequency of the third power unit 130, as the operating frequency of the first power unit 110, the second power unit 120, and the third power unit 130.

When determining the operating frequency of the first power unit 110, the second power unit 120, and the third power unit 130, the main processor 913 may determine, as the operating frequency, one of a lowest frequency (e.g., 30 kHz), an intermediate frequency (35 kHz), and a highest frequency (40 kHz), according to a set power level. When the operating frequency of the first power unit 110, the second power unit 120, and the third power unit 130 is determined as the lowest frequency, the first to fourth burners 110-1 to 110-4, the first to fourth burners 120-1 to 120-4, and the first to fourth burners 130-1 to 130-4 operate with a high power value. When the operating frequency of the first power unit 110, the second power unit 120, and the third power unit 130 is determined as the highest frequency, the first to fourth burners 110-1 to 110-4, the first to fourth burners 120-1 to 120-4, and the first to fourth burners 130-1 to 130-4 operate with a low power value.

The operating frequency determined by the main processor 913 is for operating the first power unit 110, the second power unit 120, and the third power unit 130 together and thus may be referred to as a common frequency or a synchronization frequency. The synchronization frequency denotes a frequency obtained by matching the operating frequency of the first power unit 110, the operating frequency of the second power unit 120, and the operating frequency of the third power unit 130 to a same frequency. A method by which the main processor 913 determines the operating frequencies of the first power unit 110, second power unit 120, and the third power unit 130 to one operating frequency is not limited thereto.

When the operating frequency for operating the first power unit 110, the second power unit 120, and the third power unit 130 together is determined, the main processor 913 may transmit the determined operating frequency to the first power unit 110, the second power unit 120, and the third power unit 130 to control operations of the first power unit 110, the second power unit 120, and the third power unit 130. Accordingly, the first to fourth burners 110-1 to 110-4 of which the powers are controlled by the first power unit 110, the first to fourth burners 120-1 to 120-4 of which the powers are controlled by the second power unit 120, and the first to fourth burners 130-1 to 130-4 of which the powers are controlled by the third power unit 130 operate together to heat the container, and thus, the container may quickly and uniformly cook an object to be cooked.

When a difference between the operating frequency of the first power unit 110, the operating frequency of the second power unit 120, and the operating frequency of the third power unit 130 is the threshold value or greater, the main processor 913 may stop an operation of one of the first power unit 110, the second power unit 120, and the third power unit 130 or control one of the first power unit 110, the second power unit 120, and the third power unit 130 to not operate. For example, when the threshold value is 20 KHz, the operating frequency of the first power unit 110 is 25 kHz, the operating frequency of the second power unit 120 is 30 kHz, and the operating frequency of the third power unit 130 is 70 KHz, the main processor 913 may determine the operating frequency of the first power unit 110 and the operating frequency of the second power unit 120 to be one operating frequency and control operations of the first power unit 110 and the second power unit 120 together while stopping an operation of the third power unit 130, by using the determined operating frequency.

When the difference between the operating frequency of the first power unit 110, the operating frequency of the second power unit 120, and the operating frequency of the third power unit 130 is less than the threshold value, the main processor 913 may determine the operating frequencies of the first power unit 110, the second power unit 120, and the third power unit 130 to be one operating frequency as described above, and control operations of the first power unit 110, the second power unit 120, and the third power unit 130 together by using the determined operating frequency.

The main processor 913 may transmit information about an operating state of the cooking device 100, information about a condition set in the cooking device 100 according to an input received through the input button 912, and the like, to the touch screen 911 and display same on the touch screen 911.

The memory 915 shown in FIG. 9 stores same information as the memory 620 shown in FIG. 6. However, the memory 915 further stores information related to the third power unit 130.

The memory 915 may store a program and data for performing operations of the main processor 913, according to an embodiment of the present disclosure. The memory 915 may store information about burners that are operable together from among the first to fourth burners 110-1 to 110-4, the first to fourth burners 120-1 to 120-4, and the first to fourth burners 130-1 to 130-4. The information about burners will be described in detail below with reference to FIGS. 13 and 14.

The memory 915 may include a non-volatile semiconductor memory device or a non-volatile memory, such as ROM, high-speed RAM, magnetic disk storage device, or a flash memory device. For example, the memory 915 may use, as a semiconductor memory device, an SD memory card, an SDHC memory card, a mini SD memory card, a mini SDHC memory card, a TF memory card, a micro SD memory card, a micro SDHC memory card, a memory stick, a CF, an MMC, MMC micro, or XD card. The memory 915 may also be referred to as a storage. Also, the memory 915 may include a network attached storage device accessed through a network. The memory 915 is not limited thereto.

The first power unit 110, the second power unit 120, and the third power unit 130 shown in FIG. 9 may be configured as shown in FIG. 8.

The first power unit 110 shown in FIG. 9 includes a sub-processor 921, a memory 922, and first to fourth drivers 923 to 926. The sub-processor 921 may be operated by being configured in a same manner as the sub-processor 860 of FIG. 8.

The sub-processor 921 may execute a program stored in the memory 922 and control an operation of the first power unit 110 by using data stored in the memory 922. The sub-processor 921 may control turn-on or turn-off operations of inverters included in the first to fourth drivers 923 to 926, by using an operating frequency received from the main processor 913.

The sub-processor 921 may read data stored in the memory 922 and use the same, or store data in the memory 922. For example, the sub-processor 921 may temporarily store, in the memory 922, and manage information about power levels of the first to fourth burners 110-1 to 110-4 or information about operating states of the first to fourth burners 110-1 to 110-4.

The sub-processor 921 may be configured to include the memory 922. The memory 922 may include same components as the memory 620 of FIG. 6. The memory 922 may store a program and data for performing operations of the sub-processor 921, according to an embodiment of the present disclosure. The memory 922 may store information about the first to fourth burners 110-1 to 110-4. The information about the first to fourth burners 110-1 to 110-4, stored in the memory 922, may include, for example, information about a phase angle and current flowing through the first to fourth burners 110-1 to 110-4 and information about the operating frequency of the first power unit 110, but is not limited thereto.

The first to fourth drivers 923 to 926 may each include the filter 810, the rectifier 820, the inverter 830, the current detector 840, and the distribution circuit 850 shown in FIG. 8. A power pair (N, L2) is applied to the first power unit 110 shown in FIG. 9.

The second power unit 120 shown in FIG. 9 includes a sub-processor 931, a memory 932, and first to fourth drivers 933 to 936. The sub-processor 931 is configured and operated in a same manner as the sub-processor 921, for the first to fourth burners 120-1 to 120-4. The memory 932 is configured and operated in a same manner as the memory 922, for the first to fourth burners 120-1 to 120-4. The first to fourth drivers 933 to 936 are configured and operated in a same manner as the first to fourth drivers 923 to 926, for the first to fourth burners 120-1 to 120-4. A power pair (N, L1 or L2) is applied to the second power unit 110 shown in FIG. 9.

The third power unit 130 shown in FIG. 9 includes a sub-processor 941, a memory 942, and first to fourth drivers 943 to 946. The sub-processor 941 is configured and operated in a same manner as the sub-processor 921, for the first to fourth burners 130-1 to 130-4. The memory 942 is configured and operated in a same manner as the memory 942, for the first to fourth burners 130-1 to 130-4. The first to fourth drivers 943 to 946 are configured and operated in a same manner as the first to fourth drivers 923 to 926, for the first to fourth burners 130-1 to 130-4. A power pair (N, L1) is applied to the third power unit 110 shown in FIG. 9.

FIG. 10 illustrates burners operated in the cooking device 100, according to an embodiment of the present disclosure. Referring to FIG. 10, when a container is placed on the first and second burners 110-1 and 110-2 and the first and second burners 120-1 and 120-2 as shown in FIG. 7, the operating frequencies of the first power unit 110 and second power unit 120 are determined to be one operating frequency and operations of the first power unit 110 and second power unit 120 are controlled by using the determined operating frequency. Accordingly, as shown by the reference numeral 1020 of FIG. 10, the first and second burners 110-1 and 110-2 and the first and second burners 120-1 and 120-2 are operated in a same operating frequency. Here, the operations of the first power unit 110 and second power unit 120 may be controlled by the main processor 913 or the sub-processor 921 or 931 such that a same AC power pair (L2, N) is applied to the first power unit 110 and the second power unit 120.

FIG. 11 is a functional block diagram for describing functions of the cooking device 100, according to an embodiment of the present disclosure. FIG. 11 illustrates an example of the cooking device 100 capable of determining operating frequencies of at least two of the first to third power units 110 to 130 to be the same, based on communication between communicators 1111 to 1113 included in the first to third power units 110 to 130.

The cooking device 100 of FIG. 11 includes the user interface 1122, a memory 1115, the first power unit 110, the second power unit 120, the third power unit 130, the first to fourth burners 110-1 to 110-4 of which the powers are controlled by the first power unit 110, the first to fourth burners 120-1 to 120-4 of which the powers are controlled by the second power unit 120, and the first to fourth burners 130-1 to 130-4 of which the powers are controlled by the third power unit 130, but a configuration of the cooking device 100 according to an embodiment of the present disclosure is not limited by that shown in FIG. 11.

The user interface 1122 includes the touch screen 911, the input button 912, and a main processor 1114, but a configuration of the user interface 1122 according to an embodiment of the present disclosure is not limited thereto. The touch screen 911 and the input button 912 may be configured and operated in same manners as the touch screen 911 and the input button 912 described with reference to FIG. 9. The main processor 1114 may further include, in addition to a configuration of the main processor 913 of FIG. 9, a component configured to control operations of the first power unit 110, the second power unit 120, and the third power unit 130 to determine an operating frequency, based on direct communication between the first power unit 110, the second power unit 120, and the third power unit 130.

The memory 1115 shown in FIG. 11 stores a program and data for executing the component added to the main processor 1114. Data stored in the memory 1115 may be read, written, or updated by the main processor 1114. The memory 1115 may be configured in a same manner as the memory 915 of FIG. 9.

The first power unit 110 shown in FIG. 11 includes a sub-processor 1116, a memory 1117, the communicator 1111, and the first to fourth drivers 923 to 926. The sub-processor 1116, the memory 1117, and the first to fourth drivers 923 to 926 may be configured and operated in same manners as the sub-processor 921, the memory 922, and the first to fourth drivers 923 to 926, described with reference to FIG. 9. The sub-processor 1116 and the memory 1117 may further include, in addition to configurations of the sub-processor 921 and the memory 922 described with reference to FIG. 9, components configured to perform operations based on the communicator 1111.

The second power unit 120 shown in FIG. 11 includes a sub-processor 1118, a memory 1119, the communicator 1112, and the first to fourth drivers 933 to 936. The sub-processor 1118, the memory 1119, and the first to fourth drivers 933 to 936 may be configured and operated in same manners as the sub-processor 931, the memory 932, and the first to fourth drivers 933 to 936, described with reference to FIG. 9. The sub-processor 1118 and the memory 1119 may further include, in addition to configurations of the sub-processor 931 and the memory 932 described with reference to FIG. 9, components configured to perform operations based on the communicator 1112.

The third power unit 130 shown in FIG. 11 includes a sub-processor 1120, a memory 1121, the communicator 1113, and the first to fourth drivers 943 to 946. The sub-processor 1120, the memory 1121, and the first to fourth drivers 943 to 946 may be configured and operated in same manners as the sub-processor 941, the memory 942, and the first to fourth drivers 943 to 946, described with reference to FIG. 9. The sub-processor 1120 and the memory 1121 may further include, in addition to configurations of the sub-processor 941 and the memory 942 described with reference to FIG. 9, components configured to perform operations based on the communicator 1113.

The cooking device 100 shown in FIG. 11 may control operations of the first to third power units 110 to 130 by using one operating frequency. The cooking device 100 shown in FIG. 11 may control operations of at least two of the first to third power units 110 to 130 by using one operating frequency. The cooking device 100 shown in FIG. 11 may control operations of the first to third power units 110 to 130 by using respective operating frequencies.

The communicators 1111 to 1113 included in the first to third power units 110 to 130 shown in FIG. 11 may be configured as a universal asynchronous receiver/transmitter (UART). The communicators 1111 to 1113 may be operated by being controlled by the main processor 1114.

For example, when it is identified that a location where a container is placed overlaps the first and second burners 110-1 and 110-2 and the first and second burners 120-1 and 120-2 as shown by the reference numeral 1020 of FIG. 10, and it is determined that the difference between the operating frequency of the first power unit 110 and the operating frequency of the second power unit 120 is less than the threshold value, the main processor 1114 transmits, to the sub-processors 1116 and 1118, a command to determine an operating frequency, based on mutual communication, and operate.

Accordingly, the sub-processors 1116 and 1118 transmit and receive an operating frequency by controlling operations of the respective communicators 1111 and 1112. The sub-processors 1116 and 1118 determine one operating frequency, based on a received operating frequency of another power unit and its operating frequency. For example, when the operating frequency of the first power unit 110 is 30 kHz and the operating frequency of the second power unit 120 is 40 kHz, the sub-processors 1116 and 1118 determine, as an operating frequency, one of 30 kHz (lowest frequency), 35 kHz (intermediate frequency), and 40 kHz (highest frequency), based on the mutual communication. To determine an operating frequency, based on the mutual communication, the sub-processors 1116 and 1118 may use reference information for determining whether to use the lowest frequency, the intermediate frequency, or the highest frequency. The reference information may include, for example, information indicating to use the lowest frequency, the intermediate frequency, or the highest frequency. The reference information may be stored in the memories 1117 and 1119.

When the operating frequency is determined, the sub-processors 1116 and 1118 may share information about the determined operating frequency by transmitting the determined operating frequency to each other through the communicators 1111 and 1112. The sub-processors 1116 and 1118 operate the first and second burners 110-1 and 110-2 and the first and second burners 120-1 and 120-2 together by controlling operations of the first and second drivers 923 and 924, and 933 and 934, by using the determined operating frequency.

The communicator 1113 included in the third power unit 130 may also perform an operation for determining an operating frequency as described above, by transmitting or receiving data to or from at least one of the communicator 1111 included in the first power unit 110 and the communicator 1112 included in the second power unit 120.

The cooking device 100 shown in FIG. 11 may identify burners overlapped with the container by directly transmitting or receiving data between the sub-processors 1116 to 1120 through the communicators 1111 to 1113 included in the first to third power units 110 to 130, without intervention of the main processor 1114. The cooking device 100 shown in FIG. 11 may determine an operating frequency between the first to third power units 110 to 130, based on the identified burners. The cooking device 100 shown in FIG. 11 may control operations of the first to third power units 110 to 130 by using the determined operating frequency.

When determining the operating frequency between the first to third power units 110 to 130, based on direct data transmission or reception between the sub-processors 1116 to 1120 through the communicators 1111 to 1113, the cooking device 100 shown in FIG. 11 may stop an operation of a power unit that is difficult to be operated in a same operating frequency when it is determined that at least one power unit is difficult to be operated in the same operating frequency. For example, when it is determined that the third power unit 130 is difficult to be operated in a same operating frequency, the cooking device 100 may stop an operation of the third power unit 130, based on direct data transmission or reception between the sub-processors 1116 to 1120 through the communicators 1111 to 1113.

FIG. 12 illustrates relationships between burners included in the cooking device 100 and the input buttons 1210 included in a user interface, according to an embodiment of the present disclosure.

Referring to FIG. 12, the first burner 110-1 and the second burner 110-2 of which the powers are controlled by the first power unit 110 are distinguished as a region k, the third burner 110-3 and the fourth burner 110-4 of which the powers are controlled by the first power unit 110 are distinguished as a region n, the first burner 120-1 and the second burner 120-2 of which the powers are controlled by the second power unit 120 are distinguished as a region I, the third burner 120-3 and the fourth burner 120-4 of which the powers are controlled by the second power unit 120 are distinguished as a region o, the first burner 130-1 and the second burner 130-2 of which the powers are controlled by the third power unit 130 are distinguished as a region m, and the third burner 130-3 and the fourth burner 130-4 of which the powers are controlled by the third power unit 130 are distinguished as a region p. Referring to FIG. 12, the input buttons 1210 included in the user interfaces 610, 910, and 1122 include a left rear (LR) button for selecting the region k and the region I as regions to be operated together, a right rear (RR) button for selecting the region I and the region m as regions to be operated together, a left front (LF) button for selecting the region n and the region o as regions to be operated together, and a right front (RF) button for selecting the region o and the region p as regions to be operated together.

The input buttons 1210 shown in FIG. 12 may be used as buttons for selecting regions to be operated together regardless of whether a container is placed.

When the operating frequency of the first power unit 110 and the operating frequency of the second power unit 120 are capable of being determined to be one operating frequency for operation, combinations of burners operable according to control by the input buttons 1210 shown in FIG. 12 are as shown in FIG. 13. FIG. 13 illustrates burner information stored in the cooking device 100, according to an embodiment of the present disclosure.

For example, when the LR button is selected, the main processor 913 or 1114 of the cooking device 100 recognizes that a command to operate burners of the region k and burners of the region I together is received. Accordingly, the main processor 913 or 1114 determines that the burners of the region k and the burners of the region I are burners that are operable together, based on burner information (no. 2) of FIG. 13, stored in the memory 915 or 1115, determines one operating frequency, based on the operating frequencies of the first power unit 110 and the second power unit 120, and operates the first power unit 110 and the second power unit 120 together.

For example, when the RR button is selected, the main processor 913 or 1114 of the cooking device 100 recognizes that a command to operate burners of the region I and burners of the region m together is received. Accordingly, the main processor 913 or 1114 determines that the burners of the region I and the burners of the region m are burners that are not operable together, based on burner information (no. 4) of FIG. 13, stored in the memory 915 or 1115, restricts an operation of one power unit from among the second power unit 120 and the third power unit 130, and outputs a notification message to the touch screen 911 of the user interface 910 or 1122.

For example, when the LF button is selected, the main processor 913 or 1114 of the cooking device 100 recognizes that a command to operate burners of the region n and burners of the region o together is received. Accordingly, the main processor 913 or 1114 determines that the burners of the region n and the burners of the region o are burners that are operable together, based on burner information (no. 2) of FIG. 13, stored in the memory 915, determines one operating frequency, based on the operating frequencies of the first power unit 110 and the second power unit 120, and operates the first power unit 110 and the second power unit 120 together.

For example, when the RF button is selected, the main processor 913 or 1114 of the cooking device 100 recognizes that a command to operate burners of the region o and burners of the region p together is received. Accordingly, the main processor 913 or 1114 determines that the burners of the region o and the burners of the region p are burners that are not operable together, based on burner information (no. 4) of FIG. 13, stored in the memory 915 or 1115, restricts an operation of one power unit from among the second power unit 120 and the third power unit 130, and outputs a notification message to the touch screen 911 of the user interface 910 or 1122.

When the operating frequency of the second power unit 120 and the operating frequency of the third power unit 130 are capable of being determined to be one operating frequency for operation, combinations of burners operable according to control by the input buttons 1210 shown in FIG. 12 are as shown in FIG. 14. FIG. 14 illustrates burner information stored in the cooking device 100, according to an embodiment of the present disclosure.

For example, when the LR button is selected, the main processor 913 or 1114 of the cooking device 100 recognizes that a command to operate burners of the region k and burners of the region I together is received. Accordingly, the main processor 913 or 1114 determines that the burners of the region k and the burners of the region I are burners that are not operable together, based on burner information (no. 2) of FIG. 14, stored in the memory 915 or 1115, restricts an operation of one power unit from among the first power unit 110 and the second power unit 120, and outputs a notification message to the touch screen 911 of the user interface 910 or 1122.

For example, when the RR button is selected, the main processor 913 or 1114 of the cooking device 100 recognizes that a command to operate burners of the region I and burners of the region m together is received. Accordingly, the main processor 913 or 1114 determines that the burners of the region I and the burners of the region m are burners that are operable together, based on burner information (no. 4) of FIG. 14, stored in the memory 915 or 1115, determines one operating frequency, based on the operating frequencies of the second power unit 120 and the third power unit 130, and operates the second power unit 120 and the third power unit 130 together.

For example, when the LF button is selected, the main processor 913 or 1114 of the cooking device 100 recognizes that a command to operate burners of the region n and burners of the region o together is received. Accordingly, the main processor 913 or 1114 determines that the burners of the region n and the burners of the region o are burners that are not operable together, based on burner information (no. 2) of FIG. 14, stored in the memory 915 or 1115, restricts an operation of one power unit from among the first power unit 110 and the second power unit 120, and outputs a notification message to the touch screen 911 of the user interface 910 or 1122.

For example, when the RF button is selected, the main processor 913 or 1114 of the cooking device 100 recognizes that a command to operate burners of the region o and burners of the region p together is received. Accordingly, the main processor 913 or 1114 determines that the burners of the region o and the burners of the region p are burners that are operable together, based on burner information (no. 4) of FIG. 14, stored in the memory 915 or 1115, determines one operating frequency, based on the operating frequencies of the second power unit 120 and the third power unit 130, and operates the second power unit 120 and the third power unit 130 together.

As shown in FIGS. 12, 13, and 14, when operations of burners are controlled based on buttons included in the user interface 910 or 1122 for bisected regions of the first to fourth burners 110-1 to 110-4 of which the powers are controlled by the first power unit 110, the first to fourth burners 120-1 to 120-4 of which the powers are controlled by the second power unit 120, the first to fourth burners 130-1 to 130-4 of which the powers are controlled by the third power unit 130, an operation may be pre-restricted for a burner region in which operation frequencies are unable to be determined to be one operating frequency.

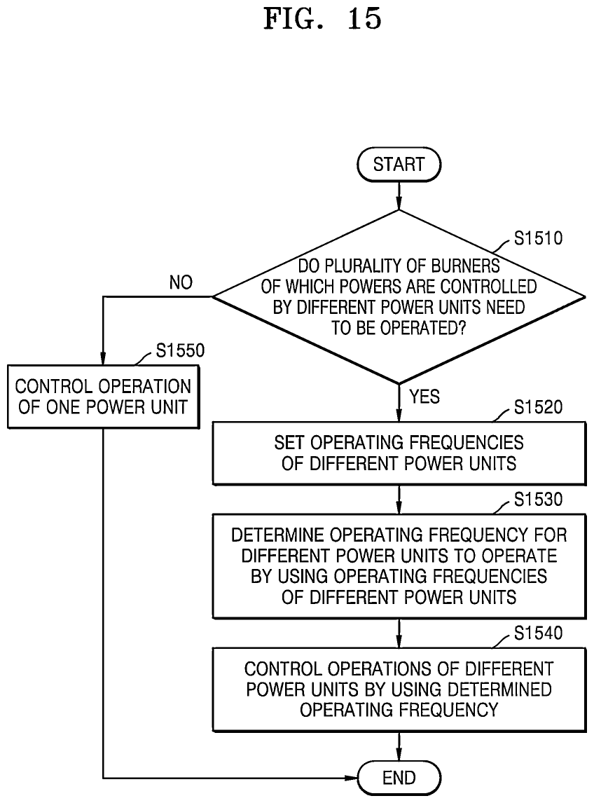

FIG. 15 is a flowchart for describing a control method for the cooking device 100, according to an embodiment of the present disclosure.

Referring to FIG. 15, in operation S1510, the main processor 630, 913, or 1114 of the cooking device 100 determines whether a plurality of burners of which powers are controlled by different power units need to be operated. Operation S1510 may be performed based on a location where a container is placed, as described with reference to FIG. 6. For example, the location where the container is placed is detected based on a phase angle and current of a burner, provided from the first power unit 110, and a phase angle and current of a burner, provided from the second power unit 120, and operation S1510 may be performed based on the detected location where the container is placed. Alternatively, operation S1510 may be performed by controlling the button 1210 of FIG. 12.

When it is determined that the plurality of burners of which the powers are controlled by the different power units need to be operated, in operation S1510, the main processor 630, 913, or 1114 of the cooking device 100 sets operating frequencies of the different power units in operation S1520. For example, the main processor 630, 913, or 1114 individually sets the operating frequency of the first power unit 110 and the operating frequency of the second power unit 120. The operating frequency may be set based on a set power level. For example, when the set power level is a high level (e.g., a level 5), the operating frequency may be set to a low frequency (e.g., 25 kHz). For example, when the set power level is a low level (e.g., a level 1), the operating frequency may be set to a high frequency (e.g., 70 kHz). Information about the power level may be input by using the input button 612 or 912 included in the user interface 610, 910, or 1122, but is not limited thereto.

In operation S1530, the main processor 630, 913, or 1114 determines an operating frequency of the different power units, based on the operating frequencies of the different power units. For example, the main processor 630, 913, or 1114 determines one operating frequency, based on the operating frequency of the first power unit 110 and the operating frequency of the second power unit 120, as described with reference to FIG. 6. For example, when the operating frequency of the first power unit 110 is 25 kHz and the operating frequency of the second power unit 120 is 35 kHz, the main processor 630, 913, or 1114 may determine one operating frequency from among 25 kHz that is a lowest frequency, 30 kHz that is an intermediate frequency, and 35 kHz that is a highest frequency.

In operation S1540, the main processor 630, 913, or 1114 controls operations of the first power unit 110 and the second power unit 120 by using the determined operating frequency, as described with reference to FIG. 6. For example, the main processor 630, 913, or 1114 transmits the determined operating frequency to each of the first power unit 110 and the second power unit 120. Accordingly, the first power unit 110 and the second power unit 120 turn on or off two switching circuits included in the inverter 830, according to the received operating frequency, thereby applying currents to the first and second burners 110-1 and 110-2 and the first and second burners 120-1 and 120-2. The container overlapping the first and second burners 110-1 and 110-2 and the first and second burners 120-1 and 120-2 is uniformly heated without dead zones.

When it is determined that the plurality of burners controlled by the different power units do not need to be operated, in operation S1510, the main processor 630, 913, or 1114 controls an operation of one power unit in operation S1550. For example, the main processor 630, 913, or 1114 may control an operation of the first power unit 110.

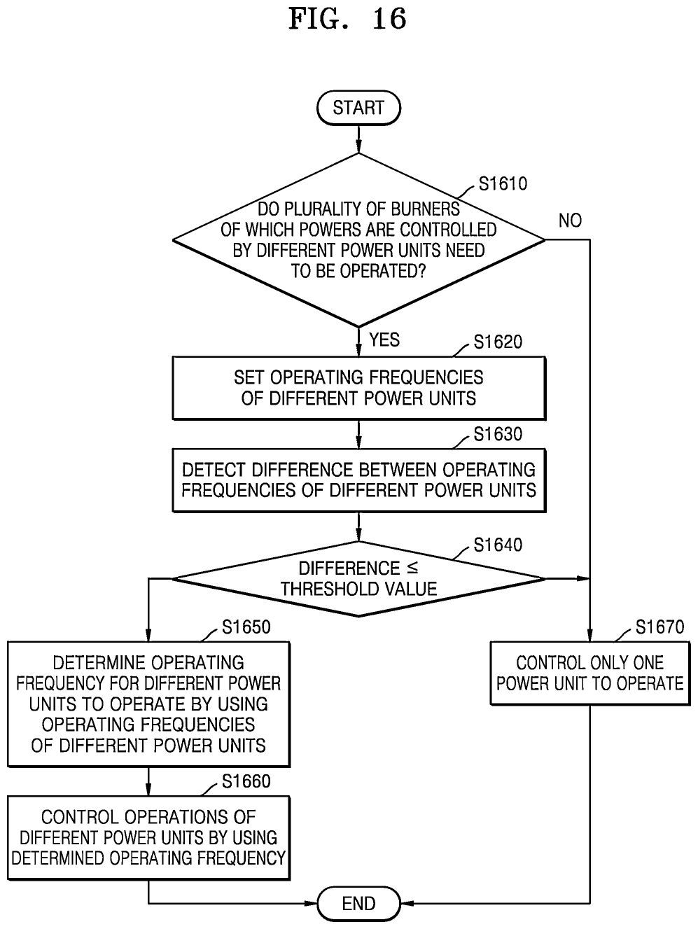

FIG. 16 is a flowchart for describing a control method for the cooking device 100, according to an embodiment of the present disclosure.

Referring to FIG. 16, in operation S1610, the main processor 630, 913, or 1114 of the cooking device 100 determines whether a plurality of burners of which powers are controlled by different power units need to be operated. Operation S1610 may be performed based on a location where a container is placed, as described with reference to FIG. 6. For example, operation S1610 may be performed based on a result of detecting the location where the container is placed, based on a phase angle and current of a burner, provided from the first power unit 110, and a phase angle and current of a burner, provided from the second power unit 120. Alternatively, operation S1610 may be performed by controlling the input button 1210 of FIG. 12.

When it is determined that the plurality of burners of which the powers are controlled by the different power units need to be operated, in operation S1610, the main processor 630, 913, or 1114 of the cooking device 100 sets operating frequencies of the different power units in operation S1620. For example, the main processor 630, 913, or 1114 sets the operating frequency of the first power unit 110 to 25 kHz and the operating frequency of the second power unit 120 to 35 kHz. The operating frequency may be set based on a set power level.

In operation S1630, the main processor 630, 913, or 1114 detects a difference between the operating frequencies of the different power units. For example, when the operating frequency of the first power unit 110 is set to 25 kHz and the operating frequency of the second power unit 120 is set to 35 kHz, the difference in operation S1630 is detected to be 10 KHz. For example, when the operating frequency of the first power unit 110 is set to 25 kHz and the operating frequency of the second power unit 120 is set to 70 KHz, the difference in operation S1630 is detected to be 55 KHz.

In operation S1640, the main processor 630, 913, or 1114 compares the detected difference with a threshold value. The threshold value may be, for example, 20 kHz. For example, when the detected difference is 10 KHz and the threshold value is 20 kHz, the main processor 630, 913, or 1114 determines that the difference is less than the threshold value and determines an operating frequency of the different power units, based on the operating frequencies of the different power units, in operation S1650. For example, when the operating frequency of the first power unit 110 is 25 kHz and the operating frequency of the second power unit 120 is 35 kHz, the main processor 630, 913, or 1114 determines, as one operating frequency, one frequency from among 25 kHz that is a lowest frequency, 30 KHz that is an intermediate frequency, and 35 kHz that is a highest frequency, as described with reference to FIG. 6.

In operation S1660, the main processor 630, 913, or 1114 controls operations of the different power units by using the determined operating frequency.

When it is determined that the plurality of burners controlled by the different power units do not need to be operated, in operation S1610, the main processor 630, 913, or 1114 controls an operation of one power unit in operation S1670. Also, when it is determined that the difference is the threshold value or greater in operation S1640, the main processor 630, 913, or 1114 controls an operation of one power unit in operation S1670. For example, when the difference is 55 kHz and the threshold value is 20 kHz, the main processor 630, 913, or 1114 determines that the difference is the threshold value or greater.

Operations of FIG. 15 and operations of FIG. 16 have been described based on an example related to the first power unit 110 and the second power unit 120, but are not limited thereto. For example, as described above with reference to FIGS. 9 and 11, the operations of FIGS. 15 and 16 may be performed based on the first power unit 110, the second power unit 120, and the third power unit 130, or may be performed based on a power unit of which power is increased or decreased according to a width of a cooking plate of the cooking device 100.

Operations S1620 to S1670 of FIG. 16 may be performed based on direct communication between the sub-processors 1116 to 1120 using the communicators 1111 to 1113 included in the first to third power units 110 to 130, as described above with reference to FIG. 11. To perform operations S1620 to S1670 of FIG. 16, based on the direct communication between the sub-processors 1116 to 1120 using the communicators 1111 to 1113, the main processor 1114 may perform operation S1610 of FIG. 16 and request the sub-processors 1116 to 1120 to perform operations S1620 to S1670 of FIG. 16, based on a result of performing operation S1610.

The cooking device 100 according to an embodiment of the present disclosure includes the plurality of burners 110-1 to 110-4, 120-1 to 120-4, or 130-1 to 130-4 including at least one working coil. The cooking device 100 according to an embodiment of the present disclosure includes the first power unit 110 configured to control power of at least one first burner from among the plurality of burners 110-1 to 110-4, 120-1 to 120-4, or 130-1 to 130-4. The cooking device 100 according to an embodiment of the present disclosure includes the second power unit 120 configured to control power of at least one second burner from among the plurality of burners. The cooking device 100 according to an embodiment of the present disclosure includes at least one processor 630, 913, or 1114 configured to, when a location where a container is placed is a location overlapping a portion of the at least one first burner and a portion of the at least one second burner, determine a third operating frequency, based on a first operating frequency of the first power unit 110 and a second operating frequency of the second power unit 120, and control the first power unit 110 and the second power unit 120 to operate together by using the determined third operating frequency.

The at least one processor 630, 913, or 1114 according to an embodiment of the present disclosure is further configured to, when a difference between the first operating frequency and the second operating frequency is a threshold value or greater, not determine the third operating frequency and control the first power unit 110 and the second power unit 120 such that an operation of one of the first power unit 110 and the second power unit 120 is stopped.

The at least one processor 630, 913, or 1114 according to an embodiment of the present disclosure is further configured to, when a difference between the first operating frequency and the second operating frequency is less than a threshold value, determine, as the third operating frequency, one of the first operating frequency, the second operating frequency, or an intermediate frequency between the first operating frequency and the second operating frequency.

The at least one processor 630, 913, or 1114 according to an embodiment of the present disclosure is further configured to, when a difference between the first operating frequency and the second operating frequency is less than a threshold value, determine, as the third operating frequency, one of the first operating frequency, the second operating frequency, or an intermediate frequency between the first operating frequency and the second operating frequency.

The cooking device 100 according to an embodiment of the present disclosure further includes the user interface 610 or 910 including at least one button for selecting burners to be operated together from among the at least one first burner and the at least one second burner. The cooking device 100 according to an embodiment of the present disclosure further includes the memory 620 or 915 storing information about burners that are operable together for the at least one first burner and the at least one second burner.

The at least one processor 630, 913, or 1114 according to an embodiment of the present disclosure is further configured to, when one button from among the at least one button is controlled, determine whether burners corresponding to the controlled button are operable together, based on the information about burners stored in the memory 620 or 915 and control operations of the first power unit 110 and the second power unit 120, based on a result of the determination.

The at least one processor 630, 913, or 1114 according to an embodiment of the present disclosure is further configured to output a notification message indication the result of the determination, through the user interface 610 or 910.

The at least one processor 630, 913, or 1114 according to an embodiment of the present disclosure is further configured to, when a difference between the first operating frequency and the second operating frequency is less than a threshold value, determine the third operating frequency, based on communication between the first power unit 110 and the second power unit 120, and control operations of the first power unit 110 and the second power unit 120 such that the first power unit 110 and the second power unit 120 operate together.

The at least one processor 630, 913, or 1114 according to an embodiment of the present disclosure is further configured to, when a difference between the first operating frequency and the second operating frequency is less than a threshold value, determine the third operating frequency, based on communication between the first power unit 110 and the second power unit 120, and control operations of the first power unit 110 and the second power unit 120 such that the first power unit 110 and the second power unit 120 operate together.

A control method for the cooking device 100 that includes the first power unit 110 configured to control power of at least one first burner from among the plurality of burners 110-1 to 110-4, 120-1 to 120-4, or 130-1 to 130-4 and the second power unit 120 configured to control power of at least one second burner from among the plurality of burners 110-1 to 110-4, 120-1 to 120-4, or 130-1 to 130-4, according to an embodiment of the present disclosure, the control method includes, when a location where a container is placed on the cooking device 100 is a location overlapping a portion of the at least one first burner and a portion of the at least one second burner, determining a third operating frequency, based on a first operating frequency of the first power unit 110 and a second operating frequency of the second power unit 120. The control method for the cooking device 100, according to an embodiment of the present disclosure, includes controlling the first power unit 110 and the second power unit 120 to operate together by using the determined third operating frequency.

The control method according to an embodiment of the present disclosure further includes, when a difference between the first operating frequency and the second operating frequency equals to or is greater than a threshold value, not determining the third operating frequency and controlling the first power unit 110 and the second power unit 120 such that an operation of one of the first power unit 110 and the second power unit 120 is stopped.

The control method according to an embodiment of the present disclosure further includes, when a difference between the first operating frequency and the second operating frequency is less than a threshold value, determining, as the third operating frequency, one of the first operating frequency, the second operating frequency, or an intermediate frequency between the first operating frequency and the second operating frequency.

The control method according to an embodiment of the present disclosure further includes determining whether the first power unit 110 and the second power unit 120 are operable together, based on a difference between the first operating frequency and the second operating frequency. The control method according to an embodiment of the present disclosure further includes outputting, through the user interface 610 or 910 included in the cooking device 100, a notification message indicating a result of the determining.

The control method according to an embodiment of the present disclosure further includes receiving a signal indicating that one button is controlled through the user interface 610 or 910 including at least one button for selecting burners to be operated together from among the at least one first burner and the at least one second burner.

The control method according to an embodiment of the present disclosure further includes determining whether burners corresponding to the controlled button are operable together, based on information about burners stored in the memory 620 or 915 of the cooking device 100, wherein the information about burners includes information about burners that are operable together for the at least one first burner and the at least one second burner.

The control method according to an embodiment of the present disclosure further includes controlling operations of the first power unit 110 and the second power unit 120, based on a result of the determining.

The control method according to an embodiment of the present disclosure further includes outputting, through the user interface 610 or 910, a notification message indicating a result of the determining.

The control method according to an embodiment of the present disclosure further includes, when a difference between the first operating frequency and the second operating frequency is less than a threshold value, determining the third operating frequency, based on communication between the first power unit 110 and the second power unit 120, and controlling operations of the first power unit 110 and the second power unit 120 such that the first power unit 110 and the second power unit 120 operate together.

A machine-readable storage medium may be provided in the form of a non-transitory storage medium. Here, the “non-transitory storage medium” only denotes a tangible device and does not contain a signal (for example, electromagnetic waves). This term does not distinguish a case where data is stored in the storage medium semi-permanently and a case where the data is stored in the storage medium temporarily. For example, the “non-transitory storage medium” may include a buffer where data is temporarily stored.

According to an embodiment, a method according to various embodiments disclosed in the present specification may be provided by being included in a computer program product. The computer program products are products that can be traded between sellers and buyers. The computer program product may be distributed in the form of machine-readable storage medium (for example, a compact disc read-only memory (CD-ROM)), or distributed (for example, downloaded or uploaded) through an application store or directly or online between two user devices (for example, smart phones). In the case of online distribution, at least a part of the computer program product (for example, a downloadable application) may be at least temporarily generated or temporarily stored in a machine-readable storage medium, such as a server of a manufacturer, a server of an application store, or a memory of a relay server.

What is claimed is:

1. A cooking device comprising:
a plurality of burners;
a first power unit configured to control power of at least one first burner from among the plurality of burners;
a second power unit configured to control power of at least one second burner from among the plurality of burners; and
at least one processor configured to, when a location where a container is placed is a location overlapping a portion of the at least one first burner and a portion of the at least one second burner,
determine a third operating frequency, based on a first operating frequency of the first power unit and a second operating frequency of the second power unit, and
control the first power unit and the second power unit to operate together by using the determined third operating frequency.

2. The cooking device of claim 1, wherein the at least one processor is further configured to,
when a difference between the first operating frequency and the second operating frequency is a threshold value or greater, not determine the third operating frequency and control the first power unit and the second power unit such that an operation of one of the first power unit and the second power unit is stopped.

3. The cooking device of claim 1, wherein the at least one processor is further configured to,
when a difference between the first operating frequency and the second operating frequency is less than a threshold value, determine, as the third operating frequency, one of the first operating frequency, the second operating frequency, or an intermediate frequency between the first operating frequency and the second operating frequency.

4. The cooking device of claim 2, wherein the at least one processor is further configured to,
when a difference between the first operating frequency and the second operating frequency is less than the threshold value, determine, as the third operating frequency, one of the first operating frequency, the second operating frequency, or an intermediate frequency between the first operating frequency and the second operating frequency.

5. The cooking device of claim 1, further comprising:
a user interface including at least one button for selecting burners to be operated together from among the at least one first burner and the at least one second burner; and
a memory storing information about burners that are operable together for the at least one first burner and the at least one second burner,
wherein the at least one processor is further configured to, when a button from among the at least one button is controlled,
determine whether burners corresponding to the controlled button are operable together, based on the information about burners stored in the memory, and
control operations of the first power unit and the second power unit, based on a result of the determination of whether the burners corresponding to the controlled button are operable together.

6. The cooking device of claim 5, wherein the at least one processor is further configured to output a notification message indication the result of the determination of whether the burners corresponding to the controlled button are operable together, through the user interface.

7. The cooking device of claim 1, wherein the at least one processor is further configured to, when a difference between the first operating frequency and the second operating frequency is less than a threshold value,
determine the third operating frequency, based on communication between the first power unit and the second power unit, and
control operations of the first power unit and the second power unit such that the first power unit and the second power unit operate together.

8. The cooking device of claim 2, wherein the at least one processor is further configured to, when a difference between the first operating frequency and the second operating frequency is less than the threshold value,
determine the third operating frequency, based on communication between the first power unit and the second power unit, and control operations of the first power unit and the second power unit such that the first power unit and the second power unit operate together.

9. A control method for a cooking device that includes a first power unit configured to control power of at least one first burner from among a plurality of burners and a second power unit configured to control power of at least one second burner from among the plurality of burners, the control method comprising:
when a location where a container is placed on the cooking device is a location overlapping a portion of the at least one first burner and a portion of the at least one second burner,
determining a third operating frequency, based on a first operating frequency of the first power unit and a second operating frequency of the second power unit; and
controlling the first power unit and the second power unit to operate together by using the determined third operating frequency.

10. The control method of claim 9, further comprising:
when a difference between the first operating frequency and the second operating frequency equals to or is greater than a threshold value,
not determining the third operating frequency and controlling the first power unit and the second power unit such that an operation of one of the first power unit and the second power unit is stopped.

11. The control method of claim 9, further comprising:
when a difference between the first operating frequency and the second operating frequency is less than a threshold value,
determining, as the third operating frequency, one of the first operating frequency, the second operating frequency, or an intermediate frequency between the first operating frequency and the second operating frequency.

12. The control method of claim 9, further comprising:
determining whether the first power unit and the second power unit are operable together, based on a difference between the first operating frequency and the second operating frequency; and
outputting, through a user interface included in the cooking device, a notification message indicating a result of the determining whether the first power unit and the second power unit are operable together.

13. The control method of claim 9, further comprising:
receiving a signal indicating that a button is controlled through a user interface including at least one button for selecting burners to be operated together from among the at least one first burner and the at least one second burner;
determining whether burners corresponding to the controlled button are operable together, based on information about burners stored in a memory of the cooking device, wherein the information about burners includes information about burners that are operable together for the at least one first burner and the at least one second burner; and
controlling operations of the first power unit and the second power unit, based on a result of the determining whether burners corresponding to the controlled button are operable together.

14. The control method of claim 13, further comprising:
outputting, through the user interface, a notification message indicating a result of the determining whether burners corresponding to the controlled button are operable together.

15. The control method of claim 12, further comprising:
when a difference between the first operating frequency and the second operating frequency is less than a threshold value,
determining the third operating frequency, based on communication between the first power unit and the second power unit, and
controlling operations of the first power unit and the second power unit such that the first power unit and the second power unit operate together.
